(19) United States
(12) Patent Application Publication
(10) Pub. No.: US 2009/0228982 A1
(43) Pub. Date: Sep. 10, 2009

(54) LICENSE TRANSFER SYSTEM, USER TERMINAL, AND LICENSE INFORMATION ISSUE SERVER

(75) Inventor: Makoto Kobayashi, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/573,449

(22) PCT Filed: Sep. 8, 2005
(86) PCT No.: PCT/JP05/16996

§ 371 Date: Feb. 8, 2007

(30) Foreign Application Priority Data
Sep. 10, 2004 (JP) 2004-264496
Sep. 6, 2005 (JP) 2005-257942

(51) Int. Cl. G06F 21/00; G06F 15/16

(52) U.S. Cl. 726/26; 709/203

(57) ABSTRACT

A license information transfer method and apparatus are disclosed. The method includes a transfer license information issue step of generating and issuing transfer license information based on revoked license information and information unique to a transfer destination device received from a user terminal, and a license key revoking step of revoking license information of a transfer source device when the transfer license information is issued in the transfer license information issue step.

### TECHNICAL FIELD

The present invention relates to a license transfer system, a user terminal, and a license information issue server.

### BACKGROUND ART

Various manners of installing options into printers are known. For example, an option is installed into a printer when it is manufactured, or a user purchases an option together with a printer and installs the option into the printer at home. Among others, at least one option feature has been installed into a product, for example, a printer, and when the user purchases the corresponding option together with the product, license information can be installed into the product to allow the user to use the option.

In this case, to prevent the license information from being copied and used by the same type of device, the license information should be unique. In this type of system, a license can be issued in exchange for information unique to a device in which software is installed so that the unauthorized use of the software by devices other than the subject device can be prevented.

To perform license control by using an information processing device, a license management system that responds to a request to use a licensed software program is disclosed in, for example, Japanese Patent Laid-Open No. 2004-139148. In this system, a technique for obtaining and transferring a license file in a multi-function device is also disclosed.

In this type of license management system, it is possible that the ID of a device that installs an application therein and executes it and the ID of an application itself are managed.

In this case, a license is issued by using the device ID and the application ID, and the application is validated by installing the license into the device.

The above-described known system does not disclose the management or issue of licenses concerning option devices related to the manufacturing of a product. Additionally, since the function or the structure of the system is not sufficient, the ease of operation is not considerably high.

When an end user replaces an old device by a new device, he/she may wish to reuse software used in the old device in the new device. This requires that the software license information be transferred from the old device to the new device. In a known license management system, however, the function or the structure is not sufficient to transfer license information between the devices while preventing the unauthorized use of the license by revoking the license in a transfer source device (old device).

### DISCLOSURE OF INVENTION

To solve the above-described problems unique to a known system, the present invention provides a system and a method for reliably revoking a license in a transfer source device and for transferring license information from an old device to a new device.

And another aspect of present invention provides a system and a method for managing license information transmission between the plural device in a concentrated manner at a license issue server.

According to an aspect of the present invention, when replacing an old device by a new device, the license for an option function used in the old device can be reliably revoked, and also, the license can be transferred from the old device to the new device.

According to another aspect of the present invention, the issuance of license information can be restricted so that an application directed to a certain destination area can be prevented from being installed in a device directed to another destination area, and also, unauthorized copying or installation of application products can be prevented.

According to an aspect of the present invention, a license transfer system includes a user terminal and a license information issue server connected to each other via a network. The user terminal includes: a revoked license information issue unit configured to generate and issue revoked license information for revoking a license of a transfer source device. The license information issue server includes: a transfer license information issue unit configured to generate and issue transfer license information based on the revoked license information received from the user terminal and information unique to a transfer destination device; and a license information revoking unit configured to revoke license information concerning an option function of the transfer source device when the transfer license information is issued by the transfer license information issue unit.

According to another aspect of the present invention, an information processing apparatus forms a network system by being connected to a license information issue server via a network. The information processing apparatus includes: a revoked license information issue unit configured to generate and issue revoked license information when transferring a license contained in a transfer source device to a transfer destination device; and a validating unit configured to validate an option function of the transfer source device by using license information received from the license information issue server.

According to another aspect of the present invention, a license information issue server includes: a transfer license information issue unit configured to generate and issue transfer license information based on revoked license information and information unique to a transfer destination device received from an information processing apparatus; and a license information revoking unit configured to revoke license information of a transfer source device when the transfer license information is issued by the transfer license information issue unit.

According to yet another aspect of the present invention, a method for controlling a user terminal and a license information issue server connected to each other via a network includes: a revoked license information issue step of generating and issuing, by the user terminal, revoked license information for revoking a license of a transfer source device; a transfer license information issue step of generating and issuing, by the license information issue server, transfer license information based on the revoked license information received from the user terminal and information unique to a transfer destination device; and a license information revoking step of revoking, by the license information issue server, license information concerning an option function of the transfer source device when the transfer license information is issued in the transfer license information issue step.

According to still another aspect of the present invention, an information processing method for use in an apparatus for controlling a network system by communicating with a license information issue server includes: a revoked license information issue step of generating and issuing revoked license information when transferring a license contained in a transfer source device to a transfer destination device; and a validating step of validating an option function of the transfer source device by using license information received from the license information issue server.

According to yet another aspect of the present invention, a license information transfer method includes: a transfer license information issue step of generating and issuing transfer license information based on revoked license information and information unique to a transfer destination device received from a user terminal; and a license information revoking step of revoking license information of a transfer source device when the license information is issued in the transfer license information issue step.

Further features of the present invention will become apparent from the following description of exemplary embodiments with reference to the attached drawings, in which like reference characters designate the same or similar parts throughout thereof.

### BRIEF DESCRIPTION OF THE DRAWINGS

FIG. 1 is a block diagram illustrating a network system including a license information issue apparatus according to an embodiment of the present invention.

FIG. 2 is a block diagram illustrating a license information issue apparatus according to an embodiment of the present invention.

FIG. 3 illustrates an example of an application list screen in an embodiment of the present invention.

FIG. 4 illustrates an example of a product-type specifying screen in an embodiment of the present invention.

FIG. 5 illustrates an example of a product registration screen in an embodiment of the present invention.

FIG. 6 illustrates an example of a product selection screen when issuing a software ID code in an embodiment of the present invention.

FIG. 7 illustrates an example of a software ID code issue screen in an embodiment of the present invention.

FIG. 8 illustrates an example of a software ID code input screen in an embodiment of the present invention.

FIG. 9 illustrates an example of a license information file issue screen in an embodiment of the present invention.

FIG. 10 illustrates an example of a license information file acquisition screen in an embodiment of the present invention.

FIG. 11 illustrates an example of a product registration screen without licensing-condition setting fields in an embodiment of the present invention.

FIG. 12 illustrates an example of a product selection screen when issuing license information in an embodiment of the present invention.

FIG. 13 illustrates an example of a license information issue screen in an embodiment of the present invention.

FIG. 14 illustrates information stored in a license information management database connected to a license information issue server in an embodiment of the present invention.

FIG. 15 is a flowchart illustrating product registration processing in an embodiment of the present invention.

FIG. 16 is a flowchart illustrating software ID code issue processing in an embodiment of the present invention.

FIG. 17 is a flowchart illustrating license information issue processing by a user in an embodiment of the present invention.

FIG. 18 is a flowchart illustrating license information issue processing by a sales company and a software developer in an embodiment of the present invention.

FIG. 19 is a flowchart illustrating device product registration processing by the license information issue server in an embodiment of the present invention.

FIG. 20 illustrates an example of a device product registration screen in an embodiment of the present invention.

FIG. 21 illustrates an example of a device product registration check screen in an embodiment of the present invention.

FIG. 22 is a flowchart illustrating option product registration processing in an embodiment of the present invention.

FIG. 23 illustrates an example of an option registration screen in an embodiment of the present invention.

FIG. 24 illustrates an example of an option product registration screen in an embodiment of the present invention.

FIG. 25 illustrates an example of an option product registration check screen in an embodiment of the present invention.

FIG. 26 illustrates an option product management database in an embodiment of the present invention.

FIG. 27 is a flowchart illustrating control processing by a license access number (LA#) issue unit in an embodiment of the present invention.

FIG. 28 illustrates an example of an option product search screen for issuing an LA# in an embodiment of the present invention.

FIG. 29 illustrates an example of an option information display screen for issuing an LA# in an embodiment of the present invention.

FIG. 30 illustrates an example of a download screen for issuing an LA# in an embodiment of the present invention.

FIG. 31 illustrates an example of an LA# input screen for issuing a license key (license information) in an embodiment of the present invention.

FIG. 32 illustrates an example of a device serial number input screen for issuing a license key in an embodiment of the present invention.

FIG. 33 illustrates an example of an information check screen for issuing a license key in an embodiment of the present invention.

FIG. 34 illustrates an example of a license key issue completion screen for issuing a license key in an embodiment of the present invention.

FIG. 35 is a flowchart illustrating license key issue processing in an embodiment of the present invention.

FIG. 36 illustrates an example of a screen to allow each actor (sales company or software developer) to log into the license information issue server with a registered login account.

FIG. 37 illustrates information stored in a license information management database connected to the license information issue server.

FIG. 38 illustrates an example of a user interface having a license-key-installation/revoked-license-key-issue function of a device for issuing a revoked license key in an embodiment of the present invention.

FIG. 39 illustrates an example of a license installation screen of a device for issuing a revoked license key in an embodiment of the present invention.

FIG. 40 illustrates an example of a screen in which a license key is installed and a function is validated in a device for issuing a revoked license key in an embodiment of the present invention.

FIG. 41 illustrates an example of a revoked-license-key display screen of a device for issuing a revoked license key in an embodiment of the present invention.

FIG. 42 is a flowchart illustrating revoked license key issue processing when installing a license key in an embodiment of the present invention.

FIG. 43 illustrates the structure of a license key in an embodiment of the present invention.

FIG. 44 illustrates an example of a license information search screen for transferring a license key in an embodiment of the present invention.

FIG. 45 illustrates an example of a license key list screen for transferring a license key in an embodiment of the present invention.

FIG. 46 illustrates an example of a license key information detail screen for transferring a license key in an embodiment of the present invention.

FIG. 47 illustrates an example of a transfer license key issue completion screen for transferring a license key in an embodiment of the present invention.

FIG. 48 is a flowchart illustrating an example of license key transfer processing in an embodiment of the present invention.

### BEST MODE FOR CARRYING OUT THE INVENTION

The present invention is described in detail below with reference to the accompanying drawings through illustration of an embodiment. The elements described in the subsequent embodiment are example only, and are not intended to restrict the scope of the invention.

### Description of Apparatus

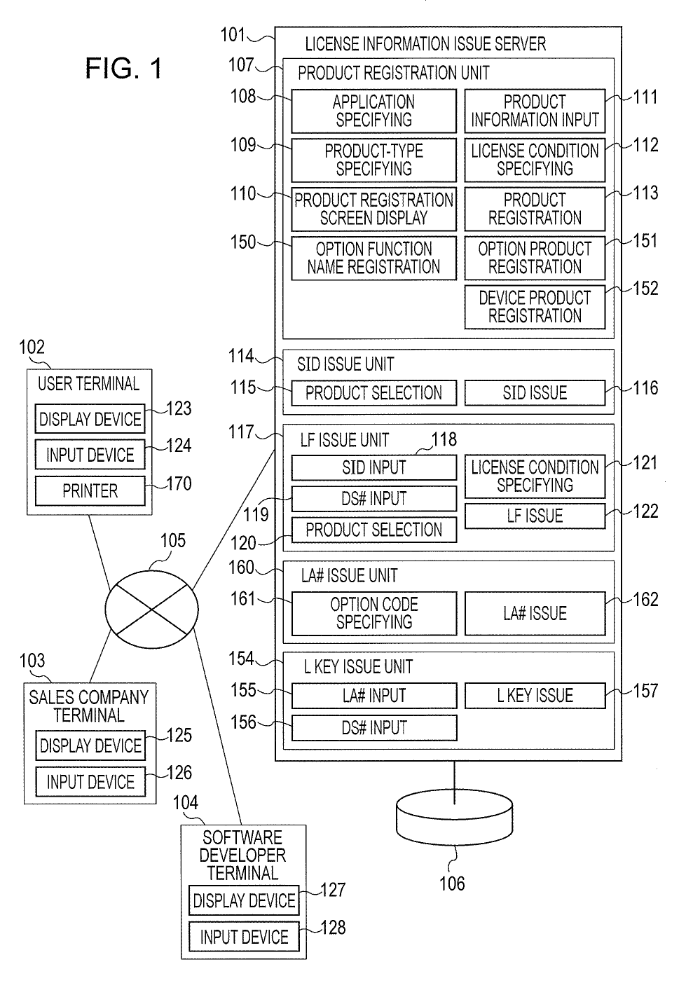

FIG. 1 is a block diagram illustrating a network system including information processing apparatuses according to an embodiment of the present invention. This network system is used for the management of software, in particular, for preventing the unauthorized use of software. In this system, license information can be issued in exchange for the input of an ID number uniquely identifying a device into which the corresponding software is installed.

The network system shown in FIG. 1 includes a license information issue server 101, which serves as an information processing apparatus for controlling the overall license information issue processing. A computer system provided for the license information issue server 101 includes functionality for server access, number requests, device number identification, license issue checking requests, device number checking, license key issuance, option information registration, identifier generation, identifier sending, etc.

The network system also includes a user terminal 102, which serves as an information processing apparatus managed by a user. Any type of information processing apparatus that can be connected to a network and can install software therein, such as a personal computer, a portable terminal, a printer, or a copying machine, can serve as the user terminal 102. The user terminal 102 can use licensed option functions that can be connected to a printer 170. The printer 170 may serve as the user terminal 102 depending on the configuration of the system. The computer system of the user terminal 102 performs functions including server access, number sending, license information checking, etc.

The network system also includes a sales company terminal 103, which serves as an information processing apparatus managed by a sales company, and a software developer (manufacturer) terminal 104, which serves as an information processing apparatus managed by a software developer. A personal computer or a workstation may be the sales company terminal 103 or the software developer terminal 104.

The network system also includes a network 105, such as the Internet, and the user terminal 102, the sales company terminal 103, and the software developer terminal 104 are connected to the license information issue server 101 via the network 105.

The network system includes a license information management database 106 connected to the license information issue server 101. The license information management database 106 stores application information, product information including license information, actor information, software ID code (SID) information, device serial number (DS#) information, device product information, device number data band information, application-IDs/device-product-code association information, option product information, license access number information, license key information, option information, and customer information.

The license information issue server 101 includes a product registration unit 107. The product registration unit 107 includes an application specifying module 108, a product-type specifying module 109, a product registration screen display module 110, a product information input module 111, a license condition specifying module 112, a product registration module 113, an option function name registration module 150, an option product registration module 151, and a device registration module 152.

The license information issue server 101 includes an SID issue unit 114. The SID issue unit 114 includes a product selection module 115, an option-code specifying module (not shown), and a SID issue module 116.

The license information issue server 101 includes a license file (LF) issue unit 117. The LF issue unit 117 includes an SID-number (SID#) input module 118, a DS-number (DS#) input module 119, a product selection module 120, a license condition specifying module 121, and an LF issue module 122.

The license information issue server 101 includes a license access (LA)# issue unit 160. The LA# issue unit 160 includes an option code specifying module 161 for specifying an option to which an LA# is issued and an LA# issue module 162 for issuing an LA# by inputting a desired number.

The license information issue server 101 includes a license key (L key) issue unit 154. The L key issue unit 154 includes an LA# input module 155, a DS# input module 156, and an L key issue module 157.

The user terminal 102 includes a display device 123 and an input device 124. The sales company terminal 103 includes a display device 125 and an input device 126. The software developer terminal 104 includes a display device 127 and an input device 128.

To install software managed by this network system into an information processing apparatus managed by the user, license information issued by the license information issue server 101 is required. The license information issue server 101 issues license information in response to authorized access via the network 105.

In the license information, ID information indicating the ID of an information processing apparatus into which software is installed can be embedded. This means that different license information is required when installing the same software into another apparatus, thus preventing unauthorized copying of the software. The license information issued by the license information issue server 101 includes a license file (LF) and a license key (L key), which are described below. License key is one example of license information.

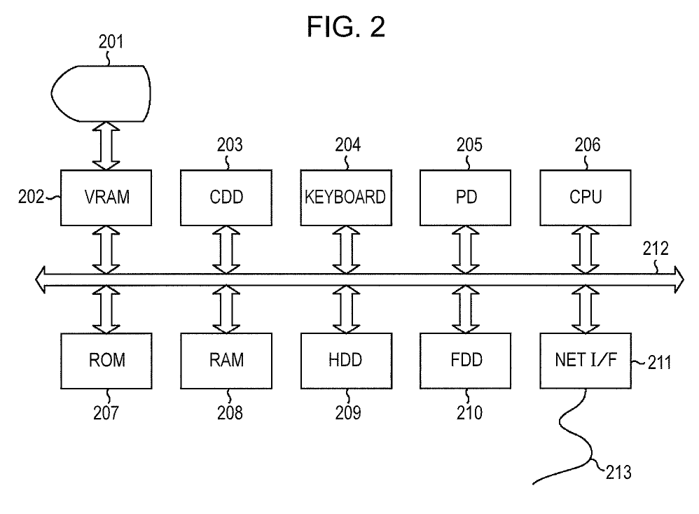

FIG. 2 is a block diagram illustrating an exemplary configuration of the license information issue server 101. A display device 201 displays, for example, windows, icons, messages, menus, and other user interface information on the display screen. A video random access memory (VRAM) 202 draws images to be displayed on the display device 201. The image data generated by the VRAM 202 is transferred to the display device 201 according to predetermined rules so that the corresponding image is displayed on the display device 201.

A compact disc drive (CDD) 203 reads and writes various control programs and data from and into recording media, such as compact disk—read-only memories (CD-ROMs) and compact disk—recordables (CD-Rs). The CDD 203 may be a digital versatile disk (DVD) drive.

A keyboard 204 includes various keys for inputting characters. A pointing device (PD) 205 is used for specifying an object, such as an icon, a menu, or another object, displayed on the screen of the display device 201. A central processing unit (CPU) 206 controls the individual devices connected to the CPU 206 based on control programs stored in a read only memory (ROM) 207, a hard disk drive (HDD) 209, a flexible disk drive (FDD) 210, and an external storage device.

The ROM 207 stores various control programs and data. A random access memory (RAM) 208 includes a work area for the CPU 206, a save area for data used during error handling, and a load area for control programs.

The HDD 209, which serves as a storage device, stores various control programs and various data. A network interface (net-I/F) 211 can communicate with printers or other information processing apparatuses via a network 213. A CPU bus 212 includes an address bus, a data bus, and a control bus. The control programs can be provided to the CPU 206, not only from the ROM 207, the HDD 209, the FDD 210, and the CDD 203, but also from other information processing apparatuses via the network 213.

The hardware configuration of the license information issue server 101 has been discussed with reference to FIG. 2, and the same configuration may be applied to the user terminal 102, the sales company terminal 103, or the software developer terminal 104.

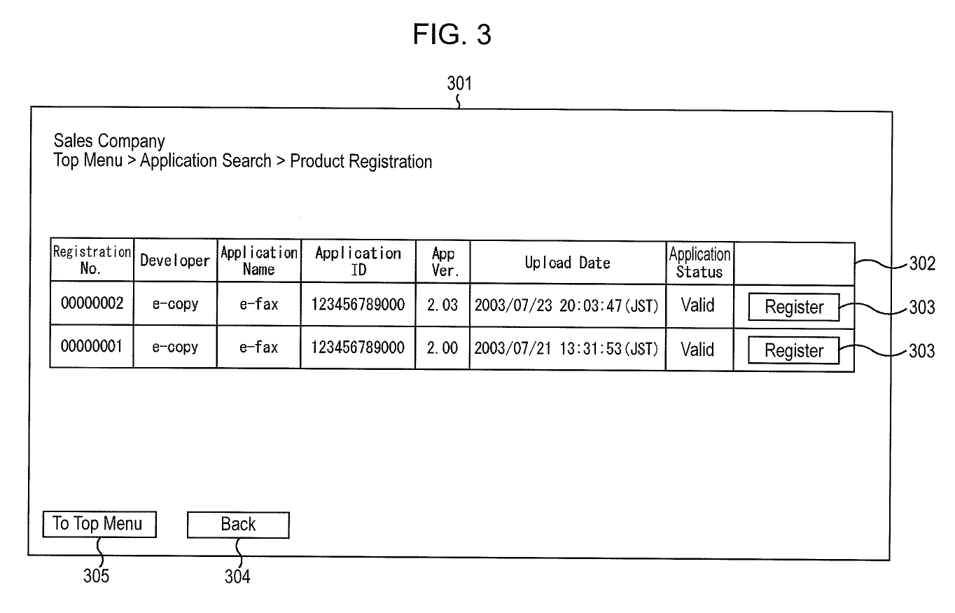

The operation of the license information issue server 101 according to this embodiment is described below with reference to FIG. 3 through 14, 36, and 37.

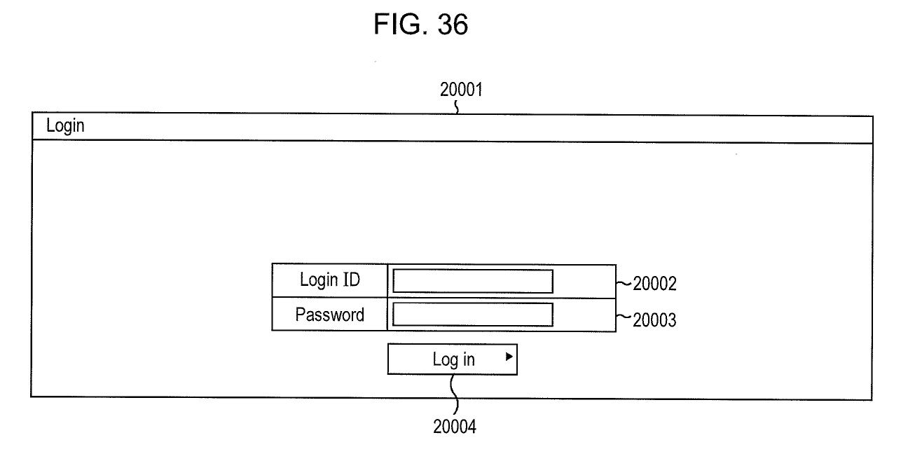

FIG. 36 is a screen to allow each actor (sales company or software developer) to log in to the license information issue server 101 with a registered login account. In FIG. 36, on a login screen 20001 includes a login ID input field 20002, a password input field 20003, and a login button 20004. The operator of the user terminal 102, the sales company terminal 103, or the software developer terminal 104 first displays this screen to log in to the system before performing a license information issue operation in the license information issue server 101.

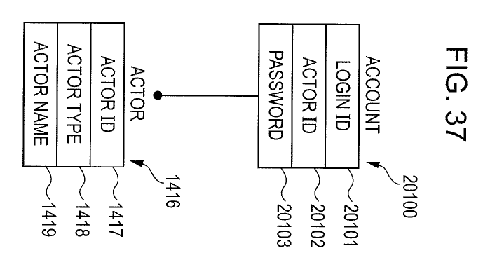

FIG. 37 illustrates information stored in the license information management database 106 connected to the license information issue server 101. The license information management database 106 stores account information and actor information.

In FIG. 37, an account table 20100 stores a login ID 20101 uniquely identifying the operator logging into this system, an actor ID 20102 uniquely identifying a sales entity, and a password 20103 used for logging into this system by the operator. An actor table 1416, which is discussed later, stores an actor ID 1417 uniquely identifying a sales entity, an actor type 1418 indicating the type of actor, i.e., a sales company or a software developer, and an actor name 1419.

FIG. 3 illustrates an example of an application specifying screen provided by the license information issue server 101. In response to access from the sales company terminal 103 via the Internet 105, the license information issue server 101 sends image data for displaying the screen shown in FIG. 3.

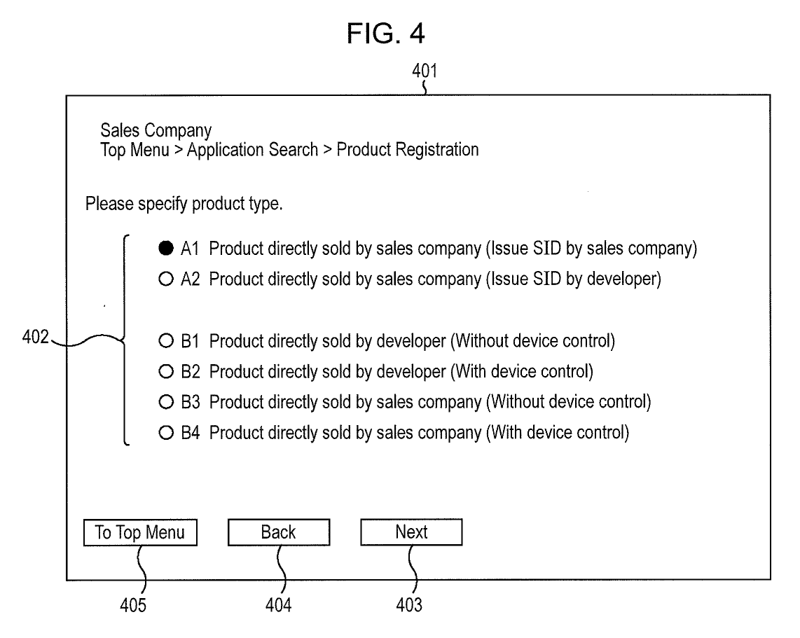

In FIG. 3, on a product registration application specifying screen 301, an application list 302 and “register” buttons 303 are shown. When registering a product, the operator of the sales company displays this product registration application specifying screen 301 to specify an application to conduct a product registration from the application list 302 registered in the system. When the “register” button 303 is selected, the screen shown in FIG. 4 is displayed. When a back button 304 is pressed, the previous screen is displayed, and when a “to top menu” button 305 is pressed, a top menu screen is displayed.

FIG. 4 illustrates an example of a product-type specifying screen 401 provided by the license information issue server 101. In response to access from the sales company terminal 103 via the Internet 105, the license information issue server 101 sends image data for displaying the screen shown in FIG. 4 to the sales company terminal 103.

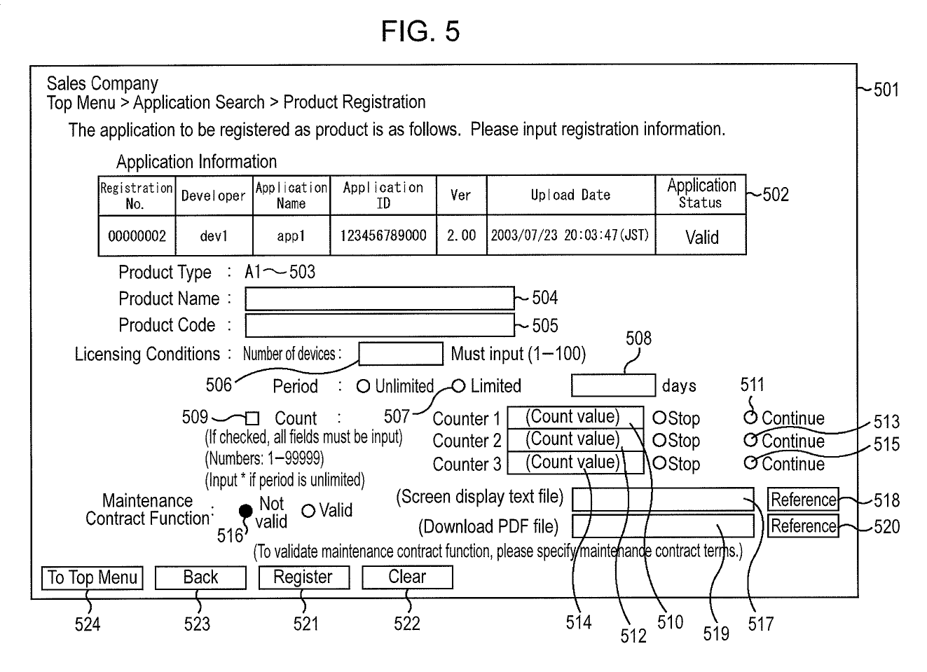

In FIG. 4, on a product-type specifying screen 401, selection radio buttons 402 for product types that can be selected are shown. After selecting the type of product to be registered in the screen shown in FIG. 4, a next button 403 is pressed, and then, the screen shown in FIG. 5 is displayed.

When a back button 404 is pressed, the previous screen is displayed, and when a “to top menu” button 405 is pressed, a top menu screen is displayed.

A product type A1 is a product directly sold by a sales company, and licensing conditions and the validity of a maintenance contract are registered. A sales company obtains a software ID code from the license information issue server 101 and sells the product by including the software ID code in a software package. The user that purchased the product inputs the software ID code and a device serial number of a computer in which the software is installed to obtain license file information from the license information issue server 101, and installs the license file information into the information processing apparatus.

A product type A2 is a product directly sold by a sales company, and licensing conditions and the validity of a maintenance contract are registered. A software developer obtains a software ID code from the license information issue server 101 and includes the software ID code in a software package. Then, a sales company sells the product, and the user that purchased the product inputs the software ID code and a device serial number of a computer in which the software is installed to obtain license file information from the license information issue server 101, and installs the license file information into the information processing apparatus.

A product type B1 is a product directly sold by a software developer, and licensing conditions are not registered. The software developer obtains license information from the license information issue server 101 by specifying licensing conditions, and sells the product by including the license information in a software package.

A product type B2 is a product directly sold by a software developer, and licensing conditions are not registered. The software developer obtains license information from the license information issue server 101 by specifying licensing conditions and a device serial number of an information processing apparatus in which the product is installed, and sells the product by including the license information in a software package.

A product type B3 is a product directly sold by a sales company, and licensing conditions are not registered. The sales company obtains license information from the license information issue server 101 by specifying licensing conditions, and sells the product by including the license information in a software package.

A product type B4 is a product directly sold by a sales company, and licensing conditions are not registered. The sales company obtains license information from the license information issue server 101 by specifying licensing conditions and a device serial number of an information processing apparatus in which the product is installed, and sells the product by including the license information in a software package.

FIG. 5 illustrates an example of a product registration screen provided by the license information issue server 101. In response to access from the sales company terminal 103 via the Internet 105, the license information issue server 101 sends image data for displaying the screen shown in FIG. 5 to the sales company terminal 103. More specifically, upon detecting that the A1 or A2 product type has been selected and the next button 403 has been pressed (from the product-type specifying screen 401), the license information issue server 101 sends the screen information shown in FIG. 5 to the terminal on which the screen shown in FIG. 4 is displayed.

In FIG. 5, a product registration screen 501 includes application information 502 concerning an application to be registered, a selected product type 503, a product name input box 504, a product code input box 505, a number-of-licensed-device input box 506, license-period-type specifying radio buttons 507, a license period input box 508 in case that the license period is a limited period, a count condition specifying check box 509, a count value input box 510 for counter 1, stop/continue specifying buttons 511 for counter 1, a count value input box 512 for counter 2, stop/continue specifying buttons 513 for counter 2, a count value input box 514 for counter 3, stop/continue specifying buttons 515 for counter 3, maintenance-contract-function valid/not-valid specifying radio buttons 516, a file name input box 517 for displaying a maintenance contract term screen, a file name specifying button 518 for displaying the maintenance contract term screen, a file name input box 519 for downloading maintenance contract terms, a file name specifying button 520 for downloading the maintenance contract terms, a register button 521, a clear button 522, a back button 523, and a “to top menu” button 524.

After checking the details of the application to be registered in this screen, the operator of the sales company inputs the product name, the product code, the number of devices to be licensed, the license period, the license count information, and the maintenance contract information, and then presses the register button 521. Then, the product is registered. When the clear button 522 is pressed, all items of information input after displaying this screen are cleared. When the back button 523 is pressed, the previous screen is displayed, and when the “to top menu” button 524 is pressed, the top menu screen is pressed.

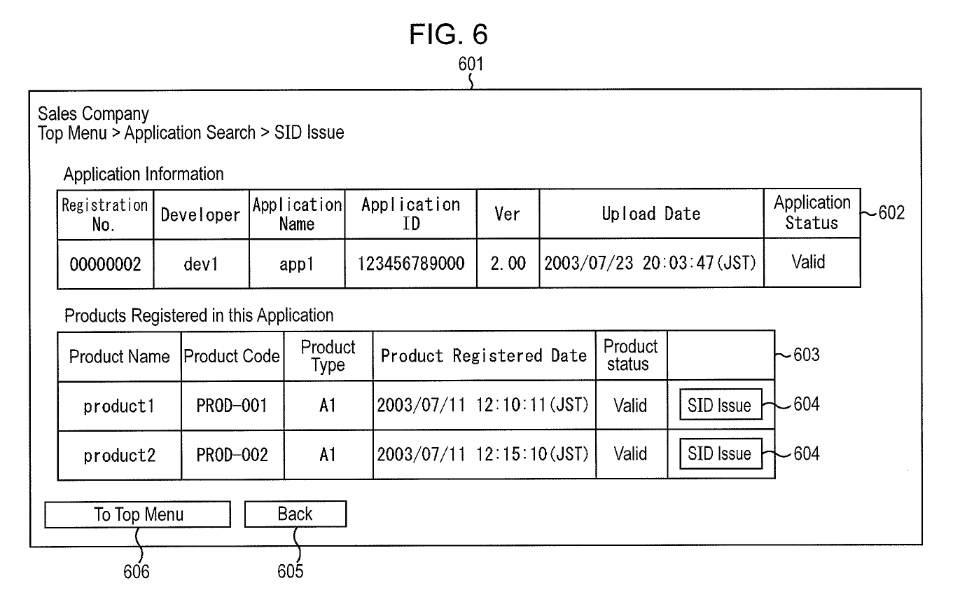

FIG. 6 illustrates an example of a software-ID-code-issuing product specifying screen provided by the license information issue server 101. In response to access from the sales company terminal 103 or the software developer terminal 104 via the Internet 105, the license information issue server 101 sends image data for displaying the screen shown in FIG. 6 to the sales company terminal 103 or the software developer terminal 104.

In FIG. 6, on a software-ID-code-issuing product specifying screen 601 includes application information 602, a product list 603 registered in this application, SID issue buttons 604, a back button 605, and a “to top menu” button 606.

When issuing a software ID code, the operator of a sales company or a software developer first displays this screen and then specifies a product to which a software ID code is issued from the product list 603 registered in the subject application selected from the applications registered in the system. When the back button 605 is pressed, the previous screen is displayed, and when the “to top menu” button 606 is pressed, the top menu screen is displayed.

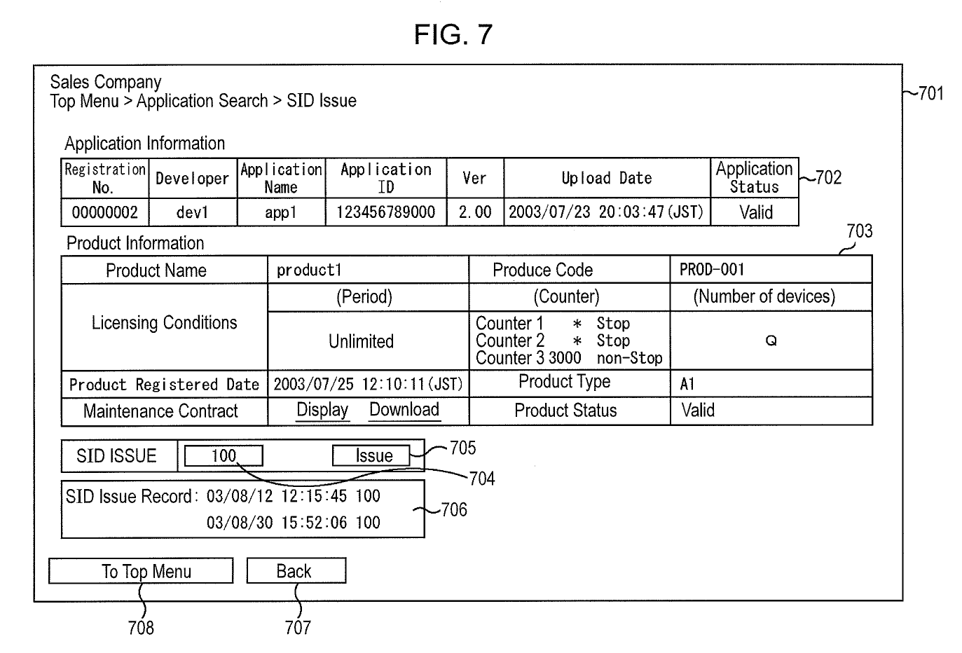

FIG. 7 illustrates an example of a software ID code issue screen in the license information issue server 101. Upon detecting that the SID issue button 604 has been selected in the screen shown in FIG. 6 displayed in the sales company terminal 103 or the software developer terminal 104, the license information issue server 101 sends image data for displaying the screen shown in FIG. 7 to the sales company terminal 103 or the software developer terminal 104 on which the screen shown in FIG. 6 is displayed.

The exemplary software ID code issue screen 701 shown in FIG. 7 includes application information 702, product information 703 concerning a product registered in the application and specified in the previous screen to which a software ID code is issued, a number-of-license input box 704 for a license to which a software ID code is issued, an issue button 705, a software ID code issue record display 706, a back button 707, and a “to top menu” button 708.

The operator of a sales company or a software developer gives an instruction to issue a software ID code by inputting the number of licenses to which the software ID code is issued into the number-of-license input box 704 and by pressing the issue button 705.

When the back button 707 is pressed, the previous screen is displayed, and when the “to top menu” button 708 is pressed, the top menu screen is displayed.

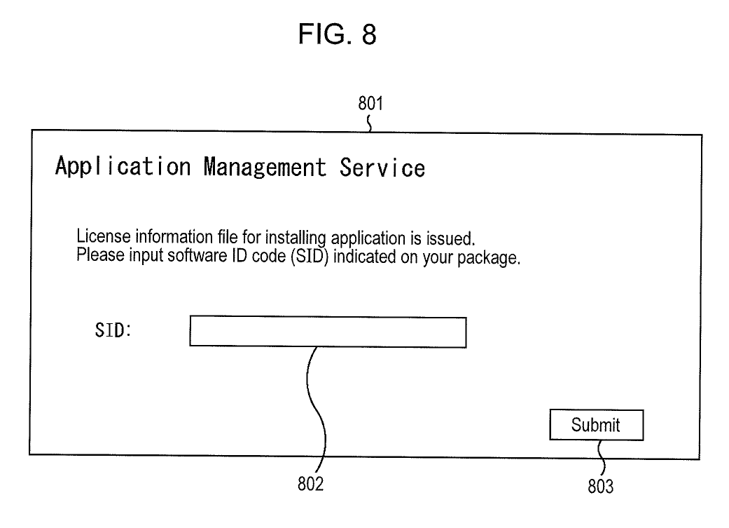

FIG. 8 illustrates an example of a software ID code input screen provided by the license information issue server 101. In response to access from the user terminal 102 via the Internet 105, the license information issue server 101 sends image data for displaying the screen shown in FIG. 8 to the user terminal 102.

In FIG. 8, on a software ID code input screen 801, a software ID code input box 802 and a submit button 803 are displayed.

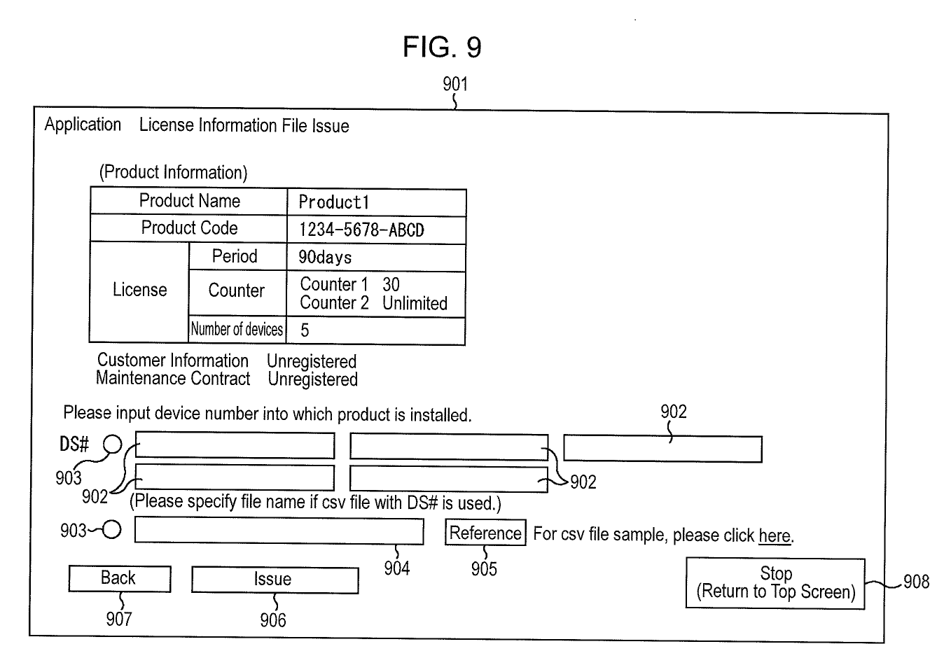

When issuing license information, the user first displays this screen and then inputs the software ID code indicated on the purchased software package into the software ID code input box 802 and presses the submit button 803. Then, the screen shown in FIG. 9 is displayed.

FIG. 9 illustrates an example of a license information issue screen provided by the license information issue server 101. Upon detecting that the submit button 803 shown in FIG. 8 in the user terminal 102 has been pressed, the license information issue server 101 sends image data for displaying the screen shown in FIG. 9 to the user terminal 102.

In FIG. 9, on a license information issue screen (indicated by “license information file issue” in FIG. 9) 901, device serial number input boxes 902, radio buttons 903 for selecting an input method for a device serial number, a device serial number file name input box 904, a reference button 905 for specifying a device serial number file, an issue button 906 for giving an instruction to issue license information, a back button 907 for returning to the previous screen, and a stop button 908 for stopping license information issue processing are displayed together with software information (indicated by “product information” in FIG. 9).

The number of device serial number input boxes 902 are equal to the smaller number of the value obtained by subtracting the number of issued licenses from the number of licenses for this software and the maximum number of device serial number input boxes that can be displayed.

After checking that the displayed software information is about the software purchased by the user, the user selects the device serial number specifying method by choosing the radio button 903.

If the user selects the upper radio button 903, he/she inputs the device serial number of the information processing apparatus to which the software is installed into the device serial number input box 902. If the user selects the lower radio button 903, he/she inputs the absolute path of the device serial number file into the device serial number file name input box 904, or the user selects the reference button 905 for specifying the device serial number file to display an operating system (OS)-standard file specifying dialog box, thus specifying the device serial number file.

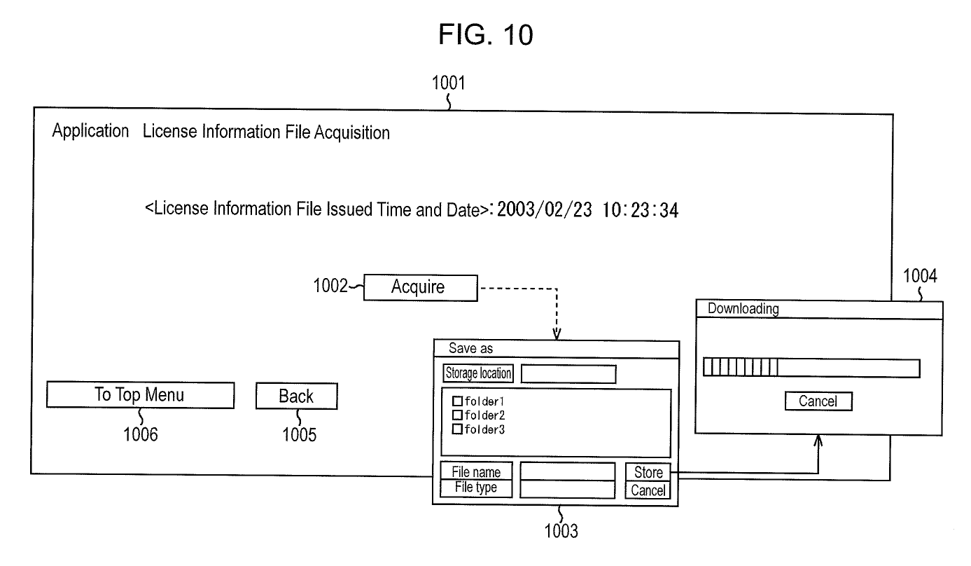

After specifying the device serial number by either of the two methods, the issue button 906 is pressed. Then, license information required for installing the software into the device corresponding to the input device serial number is generated in a predetermined location of the license information issue server 101. After completing the generation of license information, the license information issue server 101 sends image data for displaying the screen shown in FIG. 10 to the user terminal 102.

FIG. 10 is an example of a license information acquisition screen provided by the license information issue server 101.

In FIG. 10, on a license information acquisition screen (indicated by “license file acquisition” in FIG. 10) 1001, an acquire button 1002 for giving an instruction to acquire license information, a back button 1005 for returning to the previous button, and a “to top menu” button 1006 for returning to the top menu are displayed together with a license information issued time and date (indicated by “license file issued time and date” in FIG. 10).

When the user selects the acquire button 1002 for acquiring the previously issued license information (file), an OS-standard file-specifying/save dialog box 1003 is displayed. After inputting a desired storage location and a file name of license information (file), a save button is pressed. Then, an OS-standard download dialog 1004 is displayed to start downloading the license information.

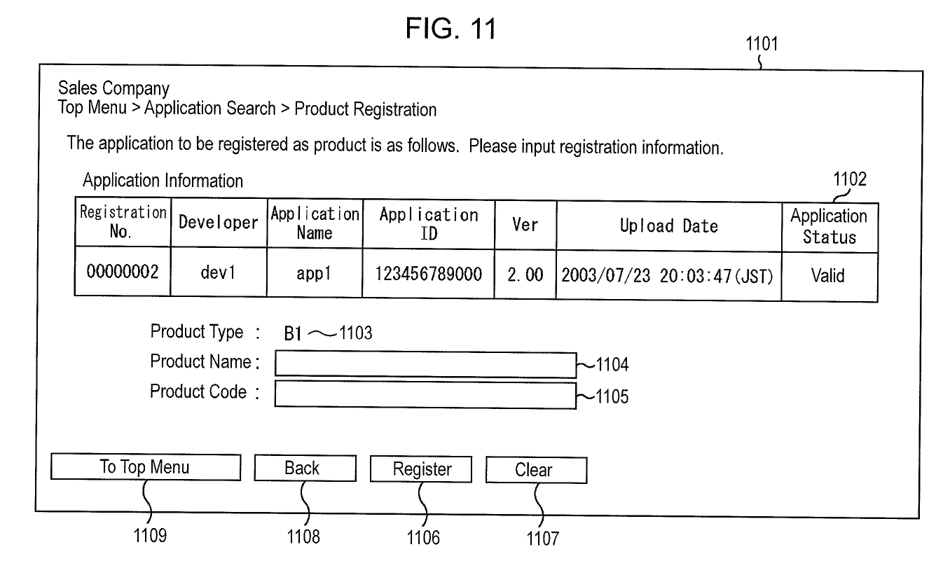

FIG. 11 illustrates an example of a product registration screen provided by the license information issue server 101 when a product type for which licensing conditions are not specified during the registration of the product is selected. In response to access from the sales company terminal 103 via the Internet 105, the license information issue server 101 sends image data for displaying the screen shown in FIG. 11 to the sales company terminal 103. More specifically, upon detecting that any one of the product types B1 through B4 in FIG. 4 has been selected and the next button 403 has been pressed, the license information issue server 101 sends the screen information shown in FIG. 11 to the terminal on which the screen shown in FIG. 4 is displayed.

In FIG. 11, a product registration screen 1101 has displayed thereon application information 1102 concerning an application to be registered, a selected product type 1103, a product name input box 1104, a product code input box 1105, a register button 1106, a clear button 1107, a back button 1108, and a “to top menu” button 1109.

After checking the details of the application to be registered in this screen, the operator of the sales company inputs the product name and the product code and presses the register button 1106. Then, the product is registered. When the clear button 1107 is pressed, all items of data input after displaying this screen are cleared. When the back button 1108 is pressed, the previous screen is displayed, and when the “to top menu” button 1109 is pressed, the top menu screen is displayed.

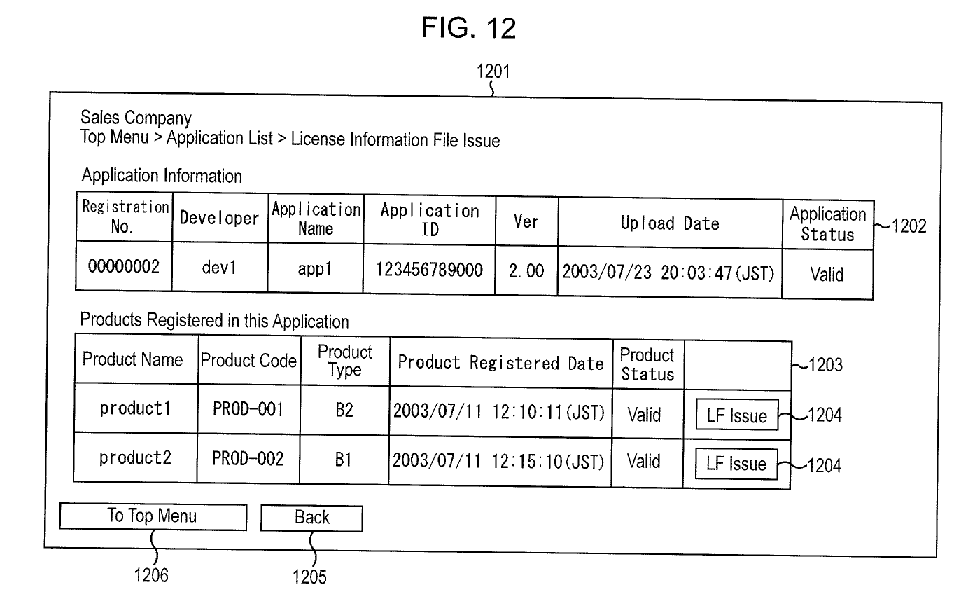

FIG. 12 illustrates an example of a license-information-file-issuing product specifying screen provided by the license information issue server 101 when a sales company or a software developer issues a license information file.

In FIG. 12, on a license-information-file-issuing product specifying screen 1201, application information 1202, a product list 1203 registered in the application, LF issue buttons 1204, a back button 1205, and a “to top menu” button 1206 are shown.

When issuing a license information file, the operator of a sales company or a software developer first displays this screen and then specifies a product to which a license information file is issued from the product list 1203 registered in the subject application selected from the applications registered in the system.

When the back button 1205 is pressed, the previous screen is displayed, and when the “to top menu” button 1206 is pressed, the top menu screen is displayed.

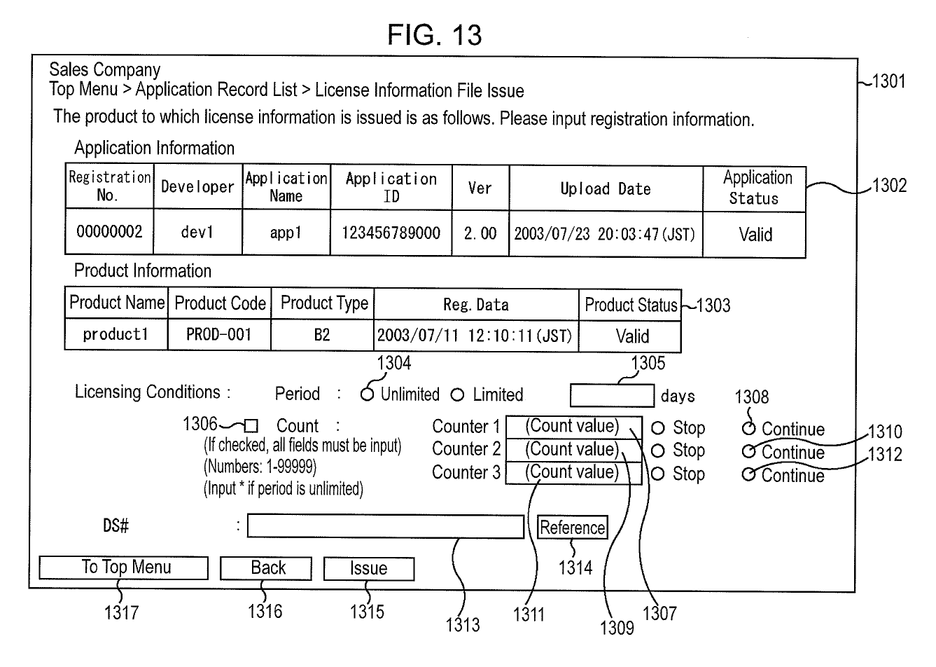

FIG. 13 illustrates an example of a license information file issue screen provided by the license information issue server 101 when a sales company or a software developer issues a license information file.

In FIG. 13, a license information file issue screen 1301 includes application information 1302 concerning an application to which a license information file is issued, selected product information 1303, license-period-type specifying radio buttons 1304, a license period input box 1305 in the case that the license period is limited, a count condition specifying check box 1306, a count value input box 1307 for counter 1, a stop/continue specifying button 1308 for counter 1, a count value input box 1309 for counter 2, a stop/continue specifying button 1310 for counter 2, a count value input box 1311 for counter 3, a stop/continue specifying button 1312 for counter 3, a device serial number input box 1313, a device serial number file specifying button 1314, an issue button 1315, a back button 1316, and a “to top menu” button 1317.

After checking the details of the application to which a license information file is issued in this screen, the operator inputs the license period, license count information, and the device serial number of the information processing apparatus to which the corresponding software is installed and presses the issue button 1315. Then, a license information file is issued. When the back button 1316 is pressed, the previous screen is displayed, and when the “to top menu” button 1317 is pressed, the top menu screen is displayed.

After completing the issue of the license information file, the screen shown in FIG. 10 is displayed, and the license information file can be obtained.

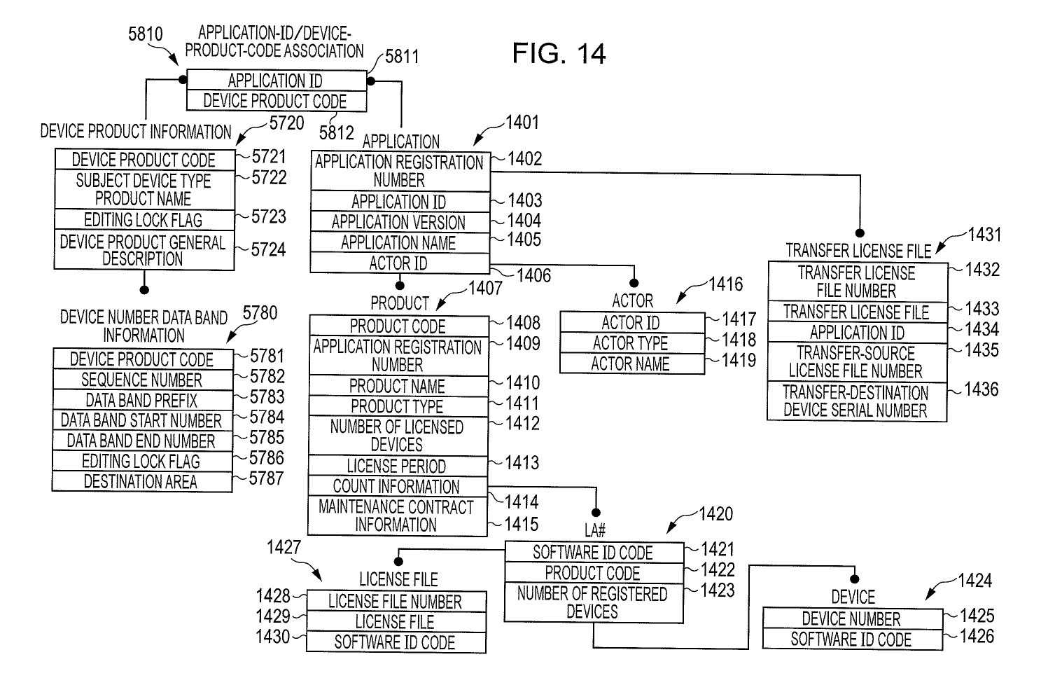

FIG. 14 illustrates information stored in the license information management database 106 connected to the license information issue server 101. The license information management database 106 includes application information, product information including license information, actor information, software ID code information, and device serial number information.

Herein, software is general software which becomes significant by being installed and operated in an information processing apparatus. An application is software developed by a software developer to perform specific processing on an information processing apparatus. A product is a sales unit determined by defining an application registered in this system by specifying a sales entity, a distribution route, licensing conditions, etc. After purchasing a product, the user installs it into his/her information processing apparatus.

An application table 1401 stores an application registration number 1402 uniquely identifying the corresponding application in this system, an application ID 1403, an application version 1404, an application name 1405, and an actor ID 1406.

A product table 1407 stores a product code 1408, an application registration number 1409, a product name 1410, a product type 1411, a number of licensed devices 1412, a license period 1413, count information 1414, and maintenance contract information 1415. When a product registration is conducted on the screens shown in FIGS. 3 through 5, the input items of information are stored in the corresponding fields of the product table 1407. Since an application and products have a “one-to-many” relationship, a plurality of products can be associated with the same application.

An actor table 1416 includes an actor ID 1417 uniquely specifying a sales entity, an actor type 1418 indicating the type of entity (actor), such as a sales company or a software developer, and an actor name 1419.

A software ID code table 1420 stores a software ID code 1421, a product code 1422, and a number of registered devices 1423. A product and software ID codes have a “one-to-many” relationship, and a plurality of software ID codes can be associated with the same product.

A device table 1424 stores a device serial number 1425 and a software ID code 1426. A software ID code and devices have a “one-to-many” relationship, and a plurality of devices can be associated with the same software ID code.

A license file table 1427 stores a license file number 1428, a license file 1429, and a software ID code 1430. A software ID code and a license file have a “one-to-one” relationship. A license file and license file numbers have a “one-to-many” relationship, and a plurality of license file numbers can be associated with the same license file.

A transfer license file table 1431 stores a transfer license file number 1432, a transfer license file 1433, an application ID 1434, a transfer-source license file number 1435, and a transfer-destination device serial number 1436. An application ID and transfer license file numbers have a “one-to-many” relationship, and a plurality of transfer license file numbers can be associated with the same application ID.

A device product information table 5720 stores a device product code 5721 uniquely identifying a product, a subject device type product name 5722, an editing lock flag 5723 indicating that updating of the device product information is prohibited depending on the LA# issued condition, and a device product general description 5724.

The device product information table 5720 and a device number data band information table 5780 have a “one-to-many” relationship, and a plurality of device number data bands can be associated with the same device product. The device number data band information table 5780 stores a device product code 5781, a sequence number 5782, a data band prefix 5783, a data band start number 5784, a data band end number 5785, an editing lock flag 5786, and a destination area 5787.

An application-ID/device-product association table 5810 stores an application ID 5811 and a device product code 5812. An application ID and device products have a “one-to-many” relationship, and a plurality of device products can be associated with the same application ID.

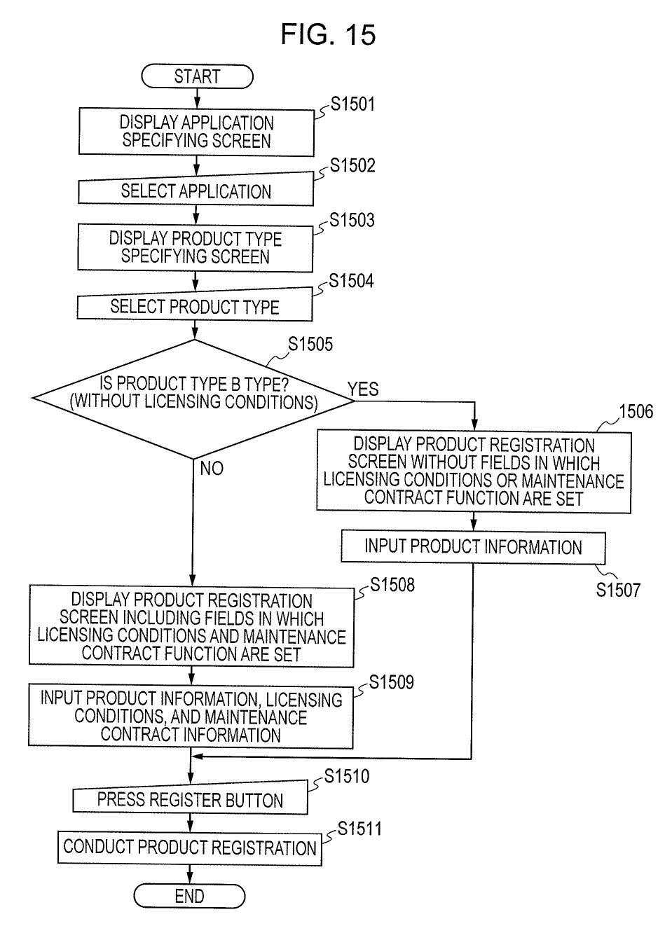

A process of this embodiment is described below with reference to the flowcharts of FIGS. 15 through 18.

### Registration of Application Products in License Information Issue Server

FIG. 15 is a flowchart illustrating product registration processing performed in the license information issue server 101 of this embodiment.

When the operator starts a predetermined product registration operation, the processing indicated by the flowchart in FIG. 15 is started. In step S1501, the application specifying screen 301 (FIG. 3) is displayed on the screen of the sales company terminal 103. Then, in step S1502, the operator of the sales company selects the register button 303 for the application. Then, in step S1503, the product-type specifying screen 401 (FIG. 4) is displayed.

In step S1504, the operator selects the product type and selects the next button 403. Then, in step S1505, it is determined whether the selected product type is the B type (whether licensing conditions are not specified). If the B type product is selected, in step S1506, the product registration screen 1101 (FIG. 11) without fields in which licensing conditions or the maintenance contract function is set is displayed.

In step S1507, the input of product information is received and processing proceeds to step S1510. If it is determined in step S1505 that the selected product is not the B type, in step S1508, the product registration screen 501 (FIG. 5) including fields in which licensing conditions and the maintenance contract function are set is displayed.

Then, in step S1509, the product information, licensing conditions, and maintenance contract information input by the operator are received. In step S1510, the operator presses the register button 521, and product registration is conducted in step S1511. The product registration processing is then completed.

### Registration of Device Products in License Information Issue Server

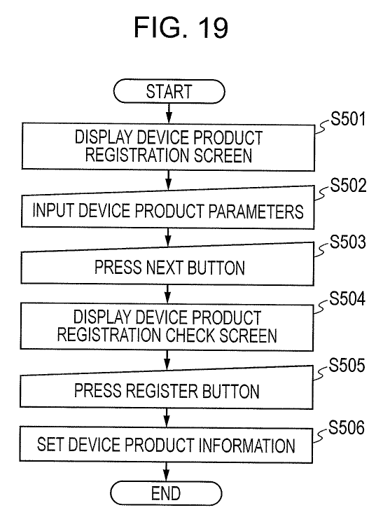

FIG. 19 is a flowchart illustrating device product registration processing performed in the license information issue server 101 of this embodiment.

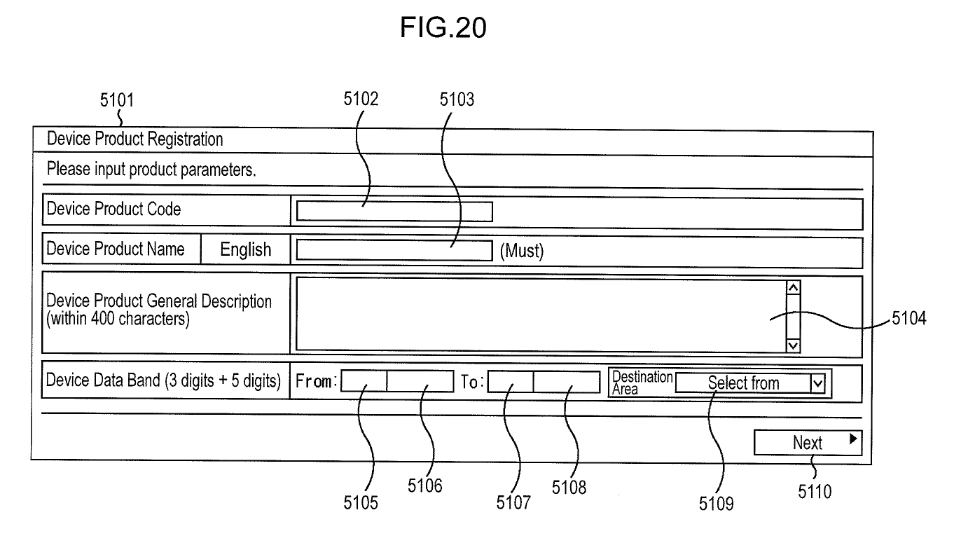

When the operator starts a predetermined device product registration operation, the processing indicated by the flowchart in FIG. 19 is started. In step S501, a device product registration screen 5101 shown in FIG. 20 is displayed to register a device product. The device product registration screen 5101 includes input fields, such as a device product code 5102, a device product name 5103, a device product general description 5104, device number data band prefixes 5105 and 5107, a device number data band start number 5106, and a device number data band end number 5108.

The device product registration screen 5101 also includes a destination area list box 5109 for specifying a registered destination area and a next button 5110. The device number data band indicates a series of device serial numbers and is used for determining whether the device serial number input by the user falls within the corresponding destination area selected here, which is discussed in detail below. The destination area indicates a sales area for device products, option products, and applications.

In step S502, the user inputs device product parameters into the input fields displayed on the device product registration screen 5101 in order to conduct a device product registration.

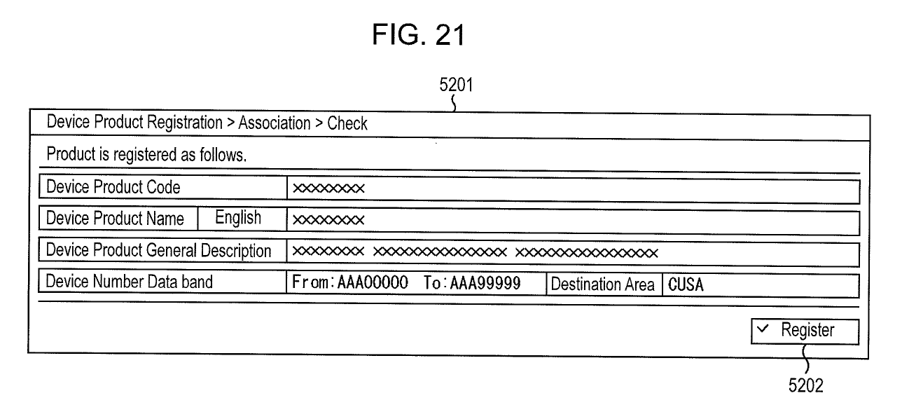

In this case, if the user presses the next button 5110 without suitably inputting the parameters, the same input screen is re-displayed. If the user suitably inputs the parameters, in step S504, the input data is displayed on a device product registration check screen 5201 shown in FIG. 21. After checking the registration details, in step S505, the user presses a register button 5202. In step S506, the device product information is set in the license information management database 106, and the device product registration processing is then completed.

### Registration of Option Products in License Information Issue Server

### Description of Product Registration Setting (Product Registration Unit 107)

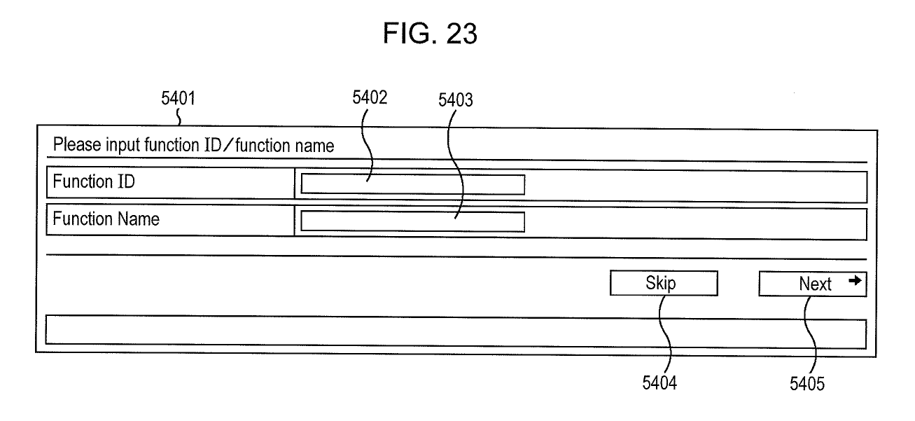

FIGS. 23 through 25 illustrate option product registration input screens provided by the license information issue server 101. More specifically, FIGS. 23, 24, and 25 illustrate examples of an option registration screen, an option product registration screen, and an option product registration check screen, respectively.

In response to access from the sales company terminal 103 via the Internet 105, the license information issue server 101 sends display data for displaying the screens shown in FIGS. 23 through 25 to the sales company terminal 103.

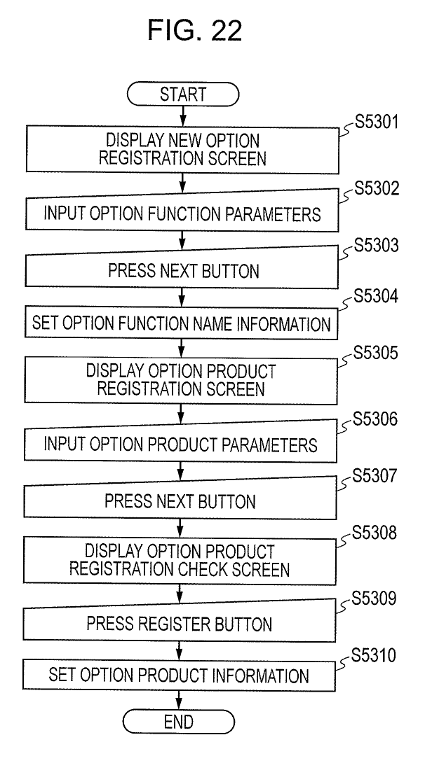

FIG. 22 is a flowchart illustrating option product registration processing performed by the license information issue server 101. The product registration is discussed below with reference to the flowchart of FIG. 22 and the screens shown in FIGS. 23 through 25.

The operator first logs in to the license information issue server 101 from the sales company terminal 103 via the Internet 105 to display an operation menu (not shown). This menu includes a product reference menu for referring to or changing registered or set products.

Upon selecting a product to be registered from the operation menu (not shown), the option product registration processing is started. In step S5301, a new option registration screen 5401 shown in FIG. 23 is displayed. The new option registration screen 5401 includes a function ID 5402, a function name 5403, a skip button 5404, and a next button 5405. In step S5302, the function ID 5402 and the function name 5403 are input, and the next button 5405 is pressed.

If it is determined upon pressing the next button 5405 that the input data is not suitable, the process returns to step S5301. If it is determined that the input data is suitable, in step S5304, option function name information is set so that the input data can be stored in the license information management database 106.

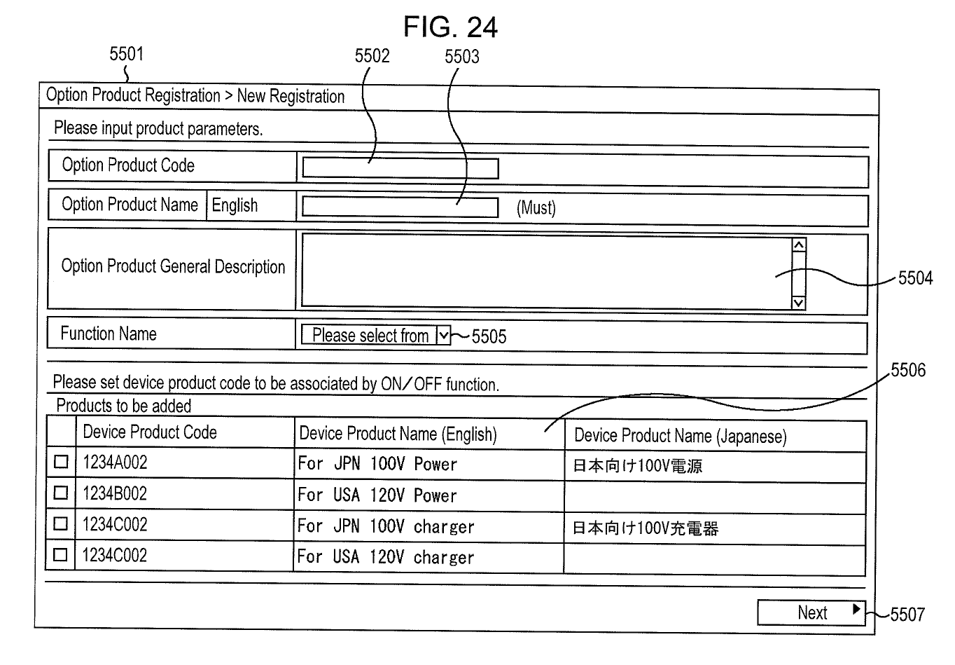

Then, in step S5305, an option product registration screen 5501 shown in FIG. 24 is displayed. The option product registration screen 5501 includes an option product code input field 5502, an option product name input field 5503, a product general description input field 5504, an option function name selection field 5505, and a registered-device product field 5506. In this registered-device product field 5506, zero (none) to a plurality of products can be selected. A next button 5507 is also provided to proceed to the subsequent operation.

In step S5306, the user fills in the option product code input field 5502, the option product name input field 5503, the product general description input field 5504, the option function name selection field 5505, and the registered-device product field 5506. Then, in step S5307, the user presses the next button 5507.

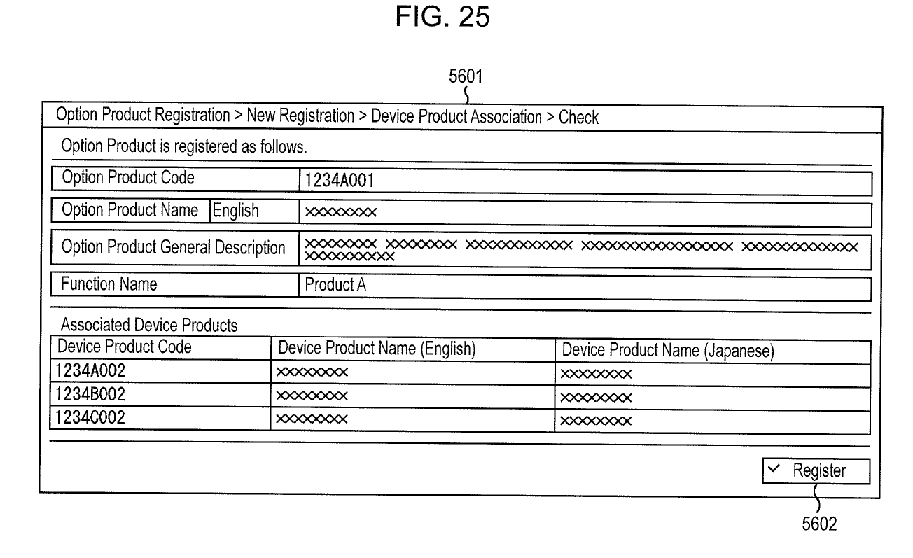

If the user presses the next button 5507 without suitably inputting data, the same input screen is re-displayed. If the user suitably inputs data, in step S5308, an option product registration check screen 5601 shown in FIG. 25 is displayed. In step S5309, the user presses a register button 5602, and the input data in the license information management database 106 is set in step S5310.

### Option Products and Device Product Management Database

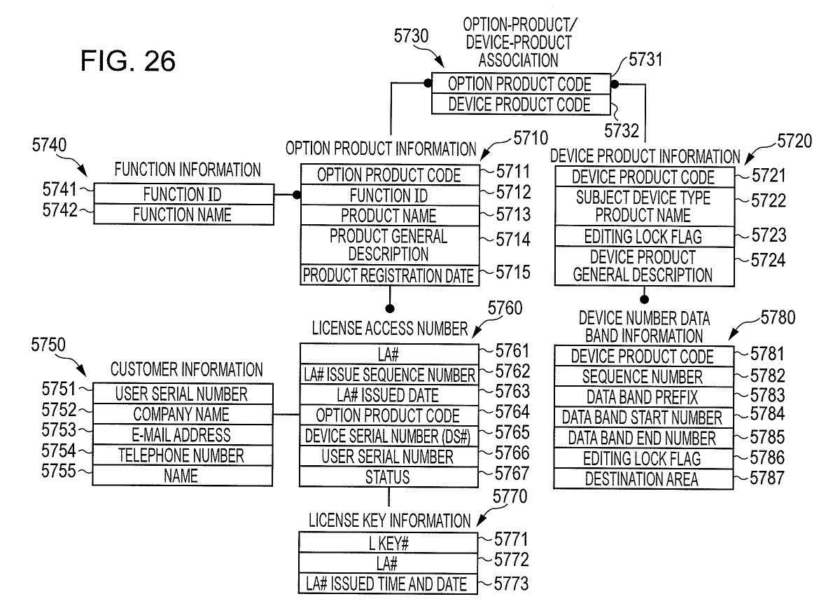

FIG. 26 illustrates information stored in the license information management database 106. The license information management database 106 includes an option product information table 5710, a device product information table 5720, an option-product/device-product association table 5730 for associating the two tables 5710 and 5720 since the two items of information have a “many-to-many” relationship, a function information table 5740, a customer information table 5750, a license access number information table 5760, a license key (L key) information table 5770, and a device number information table 5780.

In the function information table 5740, a function ID 5741 and a function name 5742 for classifying and identifying options of the printer 170 are stored. Since an option product and the function information have a “one-to-many” relationship, a plurality of functions can be associated with the same option product.

The option product information table 5710 includes an option product code 5711 that can be unique in the network system, a function ID 5712 indicating the function of an option, a product name 5713, a product general description 5714, and a product registration date 5715. Since an option product and license access numbers have a “one-to-many” relationship, a plurality of license access numbers can be associated with the same option product.

In the license access number table 5760, a license access number (LA#) 5761, a license access number (LA#) issue sequence number 5762, a license access number (LA#) issued date 5763, an option product code 5764, a device serial number (DS#) 5765, a user serial number 5766, and a license valid/not-valid status 5767 are stored.

In the customer information table 5750, a user serial number 5751, a company name 5752, an email address 5753, a telephone number 5754, and a customer name 5755 are stored.

In the license key (L key) information table 5770, a license key number (L Key#) 5771, a license access number (LA#) 5772, and an L Key# issued time and date 5773 are stored.

The device product information table 5720 and the device number data band information table 5780 are the same as the counterparts shown in FIG. 14.

In the device product information table 5720, a device product code 5721 uniquely identifying a product, a subject device type product name 5722, an editing lock flag 5723 indicating that updating of the device product information is prohibited depending on the LA# issued condition, and a device product general description 5724 are stored.

The device product information table 5720 and the device number data band information table 5780 have a “one-to-many” relationship, and a plurality of device data bands can be associated with the same device product.

In the device number band information table 5780, the device product code 5781, a sequence number 5782, a data band prefix 5783, a data band start number 5784, a data band end number 5785, an editing lock flag 5786, and a destination area 5787 are stored.

The option-product/device-product association table 5730 stores an option product code 5731 and a device product code 5732. An option product and device products have a “one-to-many” relationship, and a plurality of device products can be associated with the same option product.

### Issue of Software ID Code of Application Products by License Information Issue Server

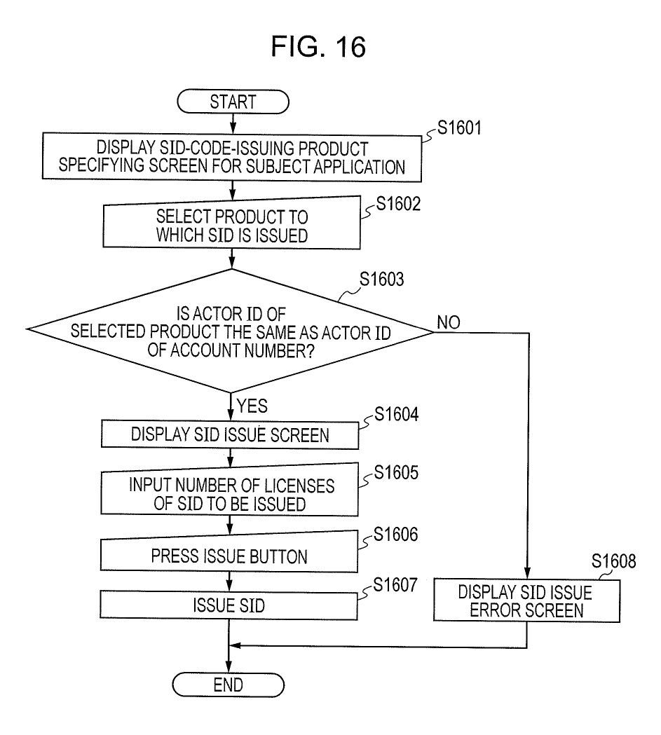

A description is now given, with reference to the flowchart of FIG. 16, of software ID code issue processing performed by a sales company or a software developer.

When the operator of a sales company or a software developer starts a predetermined software ID code issue operation, the processing indicated by the flowchart in FIG. 16 is started. In step S1601, the software-ID-code-issuing product specifying screen 601 (FIG. 6) for a subject application is displayed. Then, in step S1602, the SID issue button 604 corresponding to the product to which the software ID code is issued is selected.

Then, in step S1603, the actor ID of the selected product is compared with the actor ID of the operator account on the basis of the login ID of the sales company or the software developer and the selected product. The purpose of this comparison is to restrict the issue of the software ID code so that the issue of the software ID code is permitted only when the sales entity of the operator to issue the software ID code coincides with the sales entity of the application software in the application product by comparing the actor ID, which serves as the attribute information, concerning the application software in the application product with the actor ID of the operator to issue the software ID code. As a result, the issue of the software ID code for application products whose sales entities are different from the sales entity of the operator to request for the issue of the software ID code can be prevented. In step S1603, the information stored in the license information management database 106 shown in FIGS. 14 and 37, and the registered data are checked. More specifically, the actor ID of the operator is obtained from the actor ID 20102 of the account table 20100. Also, the application registration number 1402 of the application table 1401 that is the same as the application registration number 1409 of the product table 1407 is searched in order to obtain the actor ID of the record of the searched application registration number 1402. If it is determined in step S1603 that the actor ID of the operator and the actor ID of the selected product are not the same, in step S1608, an SID issue error screen (not shown) is displayed, and the processing is terminated. If the two actor IDs are the same, the process proceeds to step S1604.

In step S1604, the software ID code issue screen 701 (FIG. 7) is displayed.

Subsequently, in step S1605, the input of the number of licenses of the software ID code to be issued by the operator is received. In step S1606, the issue button 705 is pressed. Then, in step S1607, the software ID code is issued, and the software ID code issue processing is then completed.

### Issue of License Information on Application Products by License Information Issue Server

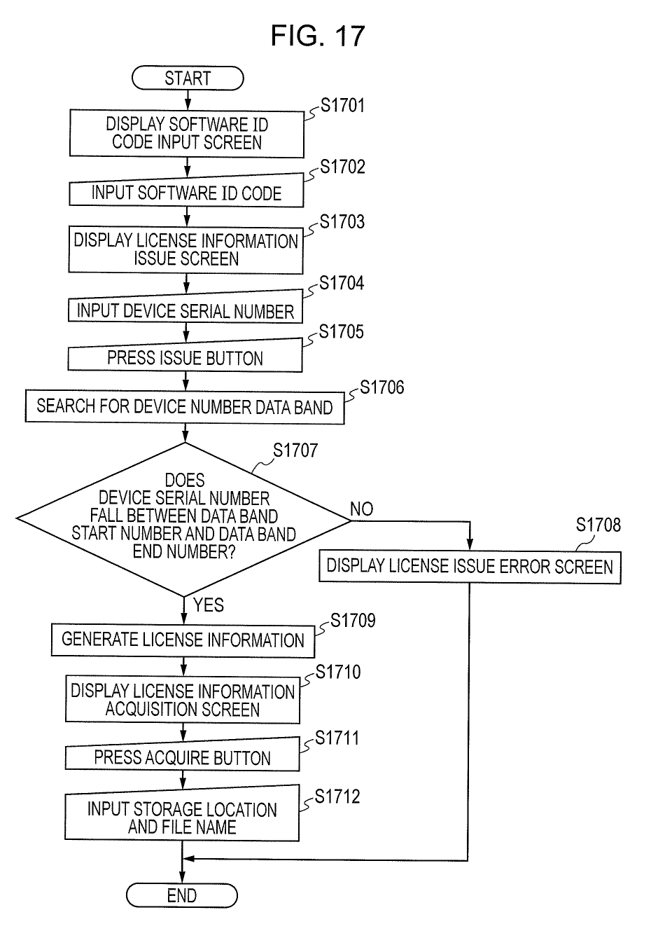

License information issue processing performed by the user is described below with reference to the flowchart of FIG. 17.

When the user starts a predetermined license information issue operation, the processing indicated by the flowchart in FIG. 17 is started. In step S1701, the software ID code input screen 801 (FIG. 8) is displayed on the display device of the user terminal 102.

Then, in step S1702, the user inputs the software ID code. Then, in step S1703, the license information issue screen 901 (FIG. 9) is displayed.

In step S1704, the user inputs the device serial number. Then, in step S1705, the user presses the issue button 906 to give an instruction to issue license information (file).

In step S1706, the license information issue server 101 searches for the device number data band on the basis of the input software ID code and the device serial number. The purpose of this search is to restrict the issue of license information to make sure that an application directed to a certain destination area is not installed in a device in another destination area by checking whether the device serial number input by the user during the license information issue processing falls within the device number data band corresponding to the software ID code input by the user during the license information issue processing.

In step S1706, the system refers to the license information management database 106 shown in FIG. 14. More specifically, the system searches the software ID code table 1420 for the software ID code input by the user and refers to the product code 1422 from the searched record. Then, the system refers to the product table 1407 from the product code 1422 to search for the record that coincides with the product code 1422.

Similarly, the system searches the application table 1401 for the application registration number 1402 and the application ID 1403, and searches for the device product code 5812 from the application ID 5811 of the application-ID/device-product association table 5810. The system also searches the device number data band information table 5780 for the data band start number 5784 and the data band end number 5785 from the device product code 5812. Then, the data band start number 5784 and the data band end number 5785 corresponding to the software ID code input by the user are obtained.

Subsequently, it is determined in step S1707 whether the device serial number input by the user falls between the data band start number 5784 and the data band end number 5785 of the device number data band information table 5780. If the device serial number input by the user falls between the data band start number 5784 and the data band end number 5785, license information can be issued. If the device serial number input by the user does not fall within the data band start number 5784 and the data band end number 5785, in step S1708, a license issue error screen (not shown) is displayed. The license information issue processing is then completed.

If an instruction to issue license information is given, in step S1709, license information is generated, and in step S1710, the license information acquisition screen 1001 (FIG. 10) is displayed. To acquire the generated license information, in step S1711, the user presses the acquire button 1002. Then, in step S1712, the OS-standard file-specifying/save dialog box 1003 is displayed, and the user inputs a desired storage location and a file name and presses the save button. The license information issue processing is then completed.

In this embodiment, the license information issue server 101 issues license information directly to the user. Alternatively, the license information issue server 101 may issue license information to a software developer, and then, the software developer transfers the license information to the user.

### Issue of License Information on Application Products by Sales Company or Software Developer

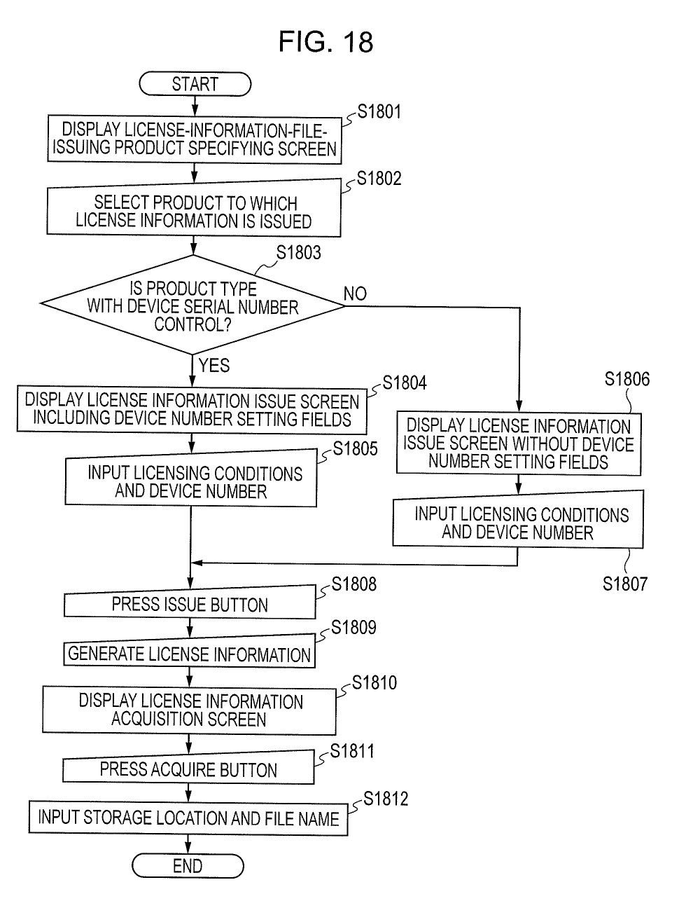

License information issue processing performed by a sales company or a software developer is discussed below with reference to the flowchart of FIG. 18.

When the operator of a sales company or a software developer starts a predetermined license information issue operation, the processing indicated by the flowchart of FIG. 18 is started. In step S1801, the license-information-file-issuing product specifying screen 1201 for a subject application (FIG. 12) is displayed.

Then, in step S1802, the selection of the LF issue button 1204 of a product to which license information is issued is received. It is then determined in step S1803 whether the product type for which the LF issue button 1204 is selected is with device serial number control. If the product is with device serial number control, in step S1804, the license information file issue screen 1301 (FIG. 13) including fields in which the device serial number is set is displayed.

Then, in step S1805, the input of licensing conditions and the device serial number by the operator is received. If it is determined in step S1803 that the product type for which the LF issue button 1204 is selected is without device serial number control, the process proceeds to step S1806 in which the license information issue screen without fields in which the device serial number is set is displayed.

Subsequently, in step S1807, the input of licensing conditions by the operator is received.

In step S1808, the issue button 1315 is pressed by the operator. Then, in step S1809, license information is generated, and in step S1810, the license information acquisition screen 1001 (FIG. 10) is displayed.

To acquire the generated license information, in step S1812, the operator presses the acquire button 1002. Then, in step S1812, the OS-standard file-specifying/save dialog box 1003 is displayed, and the operator inputs a desired storage location and presses the save button. The license information issue processing is then completed.

In this embodiment, the user can be authenticated by using the license information issued as described above, and then, he/she can install an application product into his/her device to add device functions. By conducting authentication by using license information, the unauthorized copying or installation of application products can be prevented.

### Description of License Access Number Issue for Option Products by License Information Issue Server (LA# Issue Unit 160)

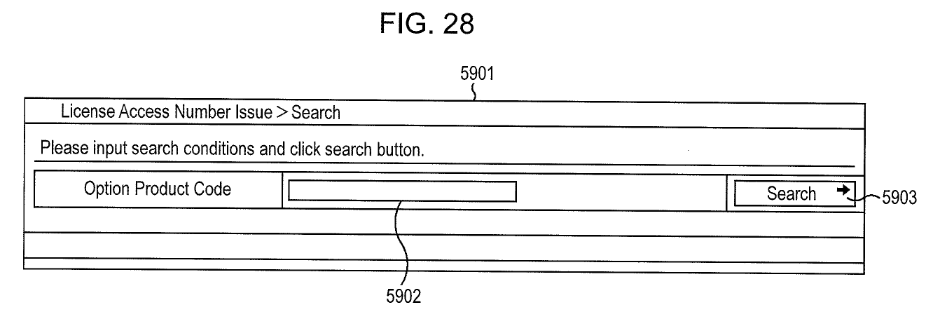

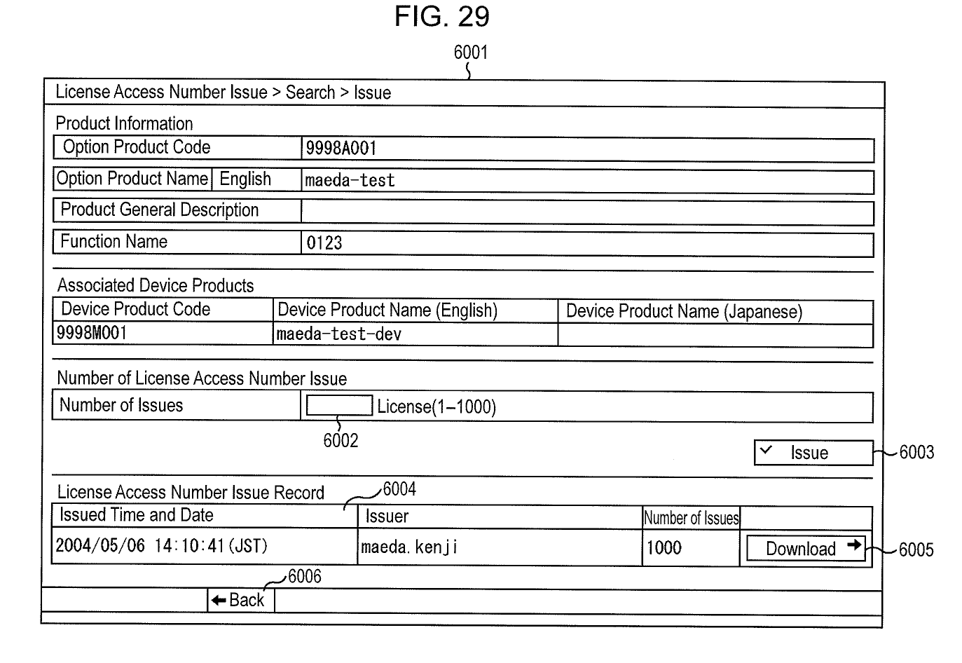

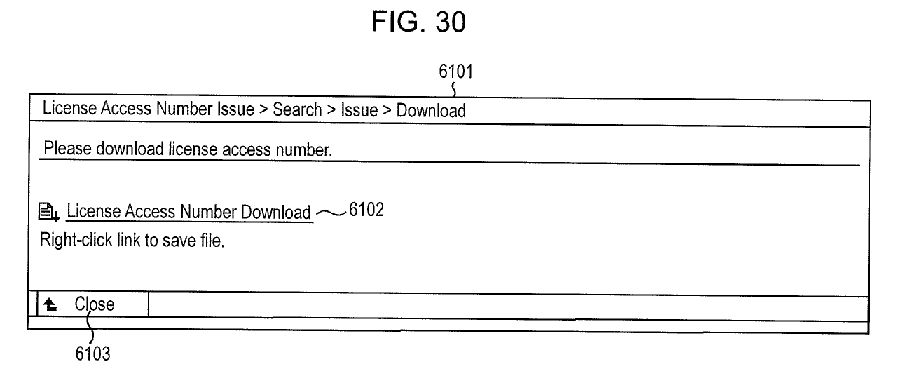

FIGS. 28 through 30 illustrate license access number (LA#) issue screens in this embodiment. More specifically, FIG. 28 illustrates an option product search screen for issuing an LA#, FIG. 29 illustrates an option information display screen for issuing an LA#, and FIG. 30 illustrates an example of a download screen for issuing an LA#.

In response to access from the sales company terminal 103 via the Internet 105, the license information issue server 101 sends display data for displaying the screens shown in FIGS. 28 through 30.

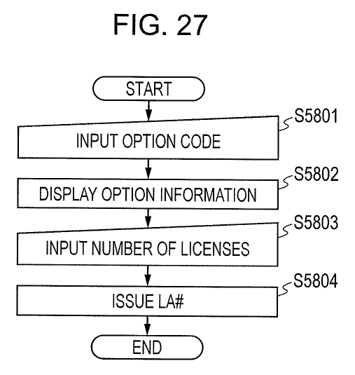

FIG. 27 is a flowchart illustrating LA# issue processing performed by the LA# issue unit 160. The LA# issue processing is discussed below with reference to the flowchart of FIG. 27 and the display screens shown in FIGS. 28 through 30.

When the sales company terminal 103 logs in, the license information issue server 101 starts the processing indicated by the flowchart in FIG. 27. In step S5801, the license information issue server 101 sends image data for displaying an option product search screen 5901 shown in FIG. 28 to the sales company terminal 103 and requests it to input the option product code.

The option product search screen 5901 is a screen for setting a desired option product to obtain a license access number. The option product search screen 5901 includes an option product input field 5902 and a search button 5903.

When the user presses the search button 5903, in step S5802, an option information display screen 6001 shown in FIG. 29 is displayed.

In step S5802, the option information of the specified product is obtained from the license information management database 106 to generate screen information. In addition to the option product information, the option information display screen 6001 shown in FIG. 29 includes a number-of-LA#-issue input field 6002, an issue button 6003, a past issue record 6004, a download button 6005 for re-downloading issued license access numbers, and a back button 6006.

When the issue button 6003 is pressed, in step S5803, an LA# download screen 6101 (FIG. 30) is generated to request the license information issue server 101 to issue license access numbers. In step S5804, the input number of license access number issues is obtained, and the same number of license access tables as the license access number issues are generated, and at the same time, license access numbers are generated and set in the tables. The generated data is stored in a file format, and display data linked to the generated file is prepared.

The download screen 6101 includes a license access number download link 6102 and a close button 6103. When the download button 6005 is pressed to re-download the issued license access numbers, in step S5804, the LA# download screen 6101 is generated, and display data linked to the file generated in the past is prepared.

### Description of License Key Issue for Option Products by License Information Issue Server (L Key Issue Module 157)

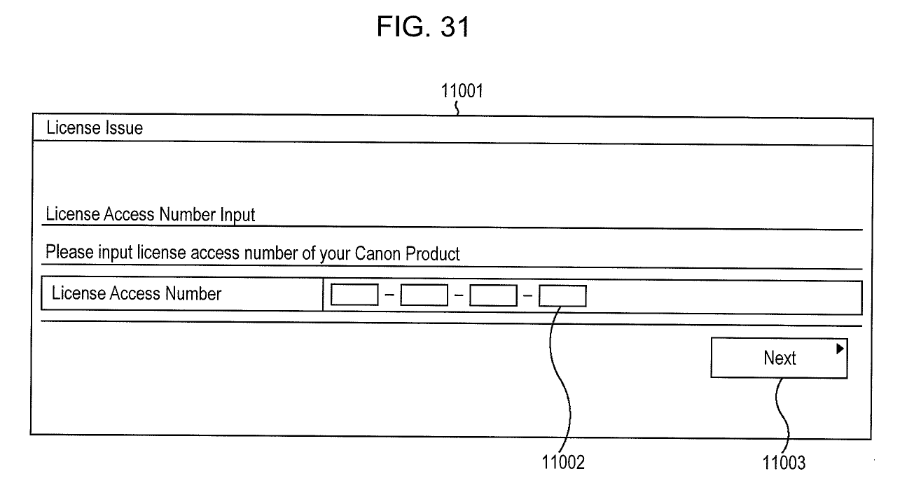

FIGS. 31 through 34 illustrate license key issue screens. In response to access from the user terminal 102 via the Internet 105, the license information issue server 101 sends display data for displaying the screens shown in FIGS. 31 through 34 to the user terminal 102.

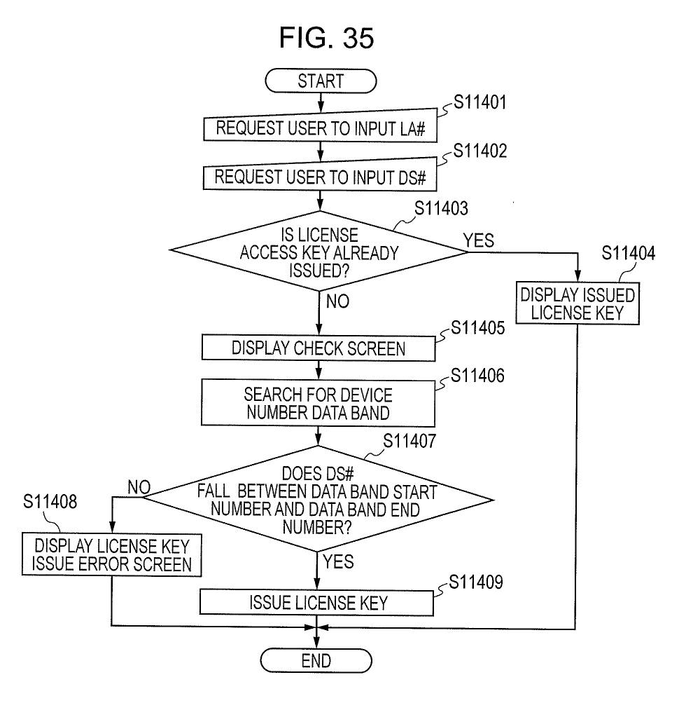

FIG. 35 is a flowchart illustrating a control process of the license key issue unit 154. The license key issue processing is discussed below with reference to the flowchart of FIG. 35 and the screens shown in FIGS. 31 through 34.

To issue license information, the user first accesses the uniform resource locator (URL) indicated in the purchased option package by using the browser of the user terminal 102. In response to the request from the user, in step S11401, the license information issue server 101 generates an access number input screen 11001 (shown in FIG. 31) and then sends the generated image data to the user terminal 102 to instruct the user to input the license access number (LA#).

The license access number (LA#) input screen 11001 includes an LA# input field 11002 and a next button 11003.

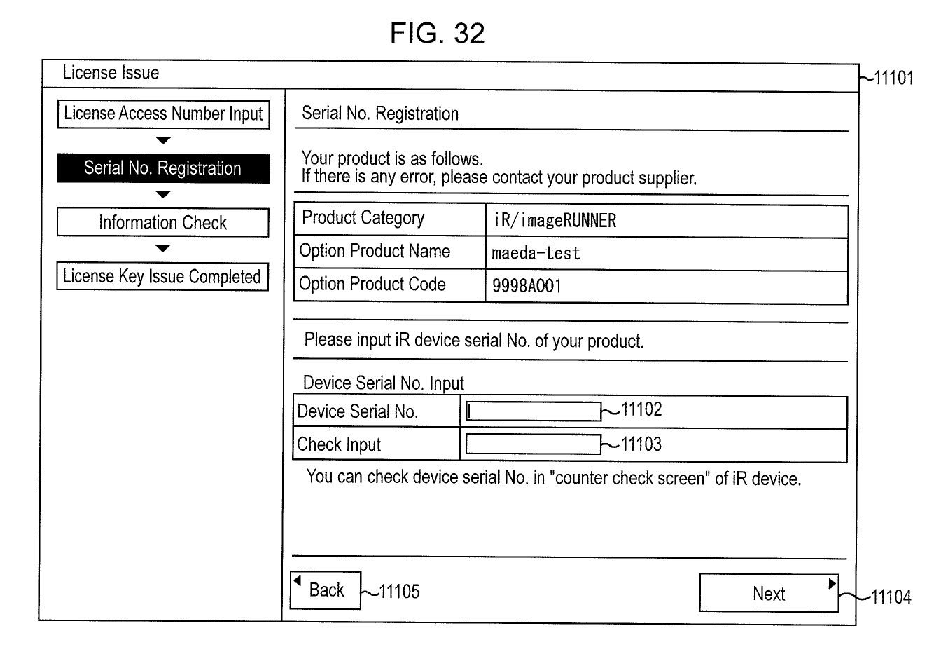

When the user inputs the license access number (LA#) indicated on the purchased option package into the LA# input field 11002 and presses the next button 11003, in step S11402, the license information issue server 101 obtains the input LA# and searches the license access number table 5760 for the information related to the option and the information related to the product to generate a registration screen 11101 shown in FIG. 32 and to request the user to input the device serial number.

The registration screen 11101 shown in FIG. 32 includes a device serial number (DS#) input field 11102, an input check field 11103, a next button 11104, and a back button 11105. The user inputs the device serial number and presses the next button 11104.

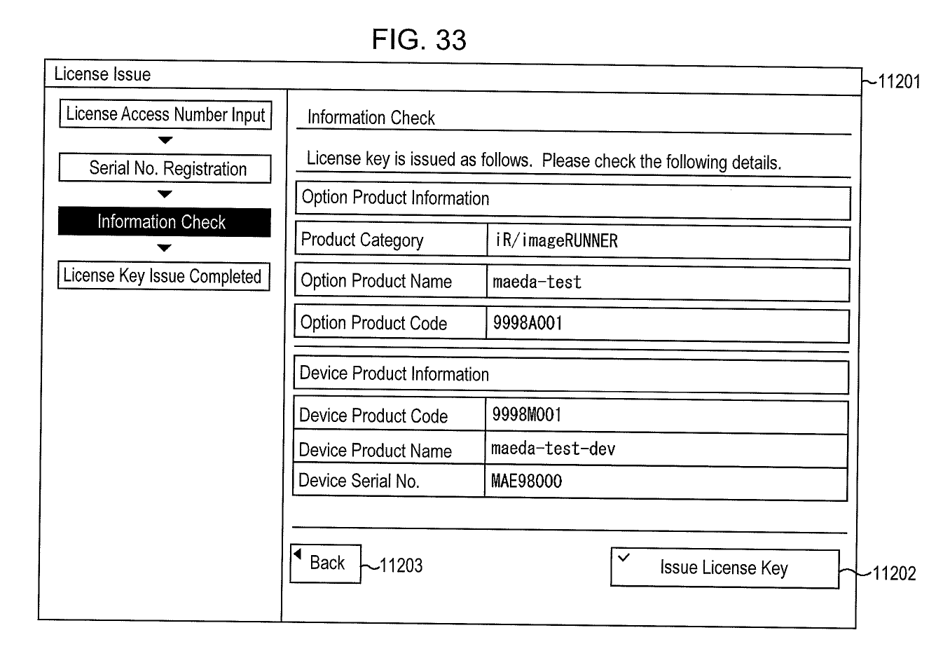

It is then determined in step S11403 after checking the input device serial number whether a license key has already been issued for this device. If the license key has not been issued, the process proceeds to step S11405 in which an information check screen 11201 shown in FIG. 33 to instruct the user to check the license issue is displayed.

The information check screen 11201 includes a license issue button 11202 and a back button 11203. Upon pressing the license issue button 11202, the process proceeds to step S11406.

In step S11406, the license information issue server 101 searches for the device number data band on the basis of the input software ID code and the device serial number. The purpose of this search is to restrict the issue of a license key to make sure that an option product directed to a certain destination area is not valid in a device in another destination area by checking whether the device serial number input by the user during the license key issue processing falls within the device number data band corresponding to the license access number (LA#) input by the user during the license key issue processing.

That is, in step S11406, the license information issue server 101 searches the license information management database 106. More specifically, the license information issue server 101 searches the license access number (LA#) table 5760 for the license access number (LA#) input by the user and searches for the option product code 5764 from the searched record. Then, the license information issue server 101 searches the option product information table 5710 from the option product code 5764 for the record that coincides with the option product code 5764.

Then, the license information issue server 101 searches for the device product code 5732 from the option product code 5731 of the option-product/device-product association table 5730. The license information issue server 101 further searches for the device product code 5721 of the device product information table 5720 from the device product code 5732, and then searches the device number data band information table 5780 for the data band start number 5784 and the data band end number 5785. In this manner, the data band start number 5784 and the data band end number 5785 associated with the license access number (LA#) input by the user can be obtained.

Then, it is determined in step S11407 whether the device serial number input by the user falls between the data band start number 5784 and the data band end number 5785 of the device number data band information table 5780. If the device serial number input by the user falls between the data band start number 5784 and the data band end number, a license key can be issued, and the process proceeds to step S11409.

On the other hand, if the device serial number input by the user does not fall between the data band start number 5784 and the data band end number 5785, in step S11408, a license key issue error screen (not shown) is displayed. The license key issue processing is then terminated.

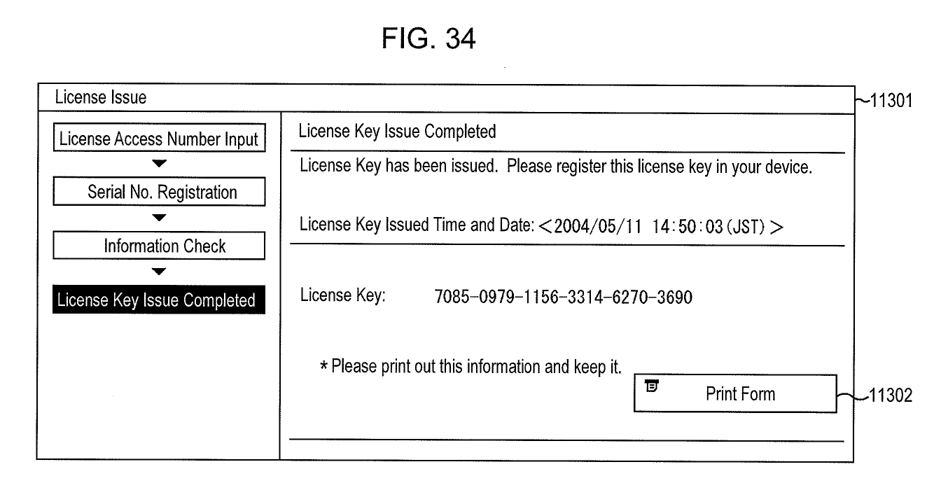

In step S11409, an encrypted license key number (L Key#) is generated by using the input device serial number and the set option number, and is registered in the license information management database 106. The license information issue server 101 also generates a license key number (L Key#) display screen 11301 shown in FIG. 34. The L Key# display screen 11301 includes a button 11302 for printing out the information on this screen by using the browser.

If it is determined in step S11403 that a license key has already been issued, the process proceeds to step S11404. In step S11404, the encrypted license key number (L Key#) is obtained from the license information management database 106 by using the input device serial number and the set option number, and the license key number (L Key#) display screen 11301 is generated.

The user inputs the obtained license key into a device, such as a printer, to use the corresponding option. The device then encrypts the license key from the device serial number and the option number set in the device in a manner similar to the license information issue server 101 to generate a license key number (L Key#), and compares the generated L Key# with the input L Key#. If the two licenses key numbers are the same, the option function can be started. With this operation, the manufactured and distributed devices and options thereof can be controlled by the license information issue server 101.

Although in the above description the device to use the option is separately provided from the user terminal 102, the user terminal 102 may be an integrated system to use the browser and to input the license key (L Key#), that is, the configuration of the user terminal 102 is not restricted. To implement the present invention, the order of the option product registration and the device registration may be reversed.

### Description of Revoked License Key Issue

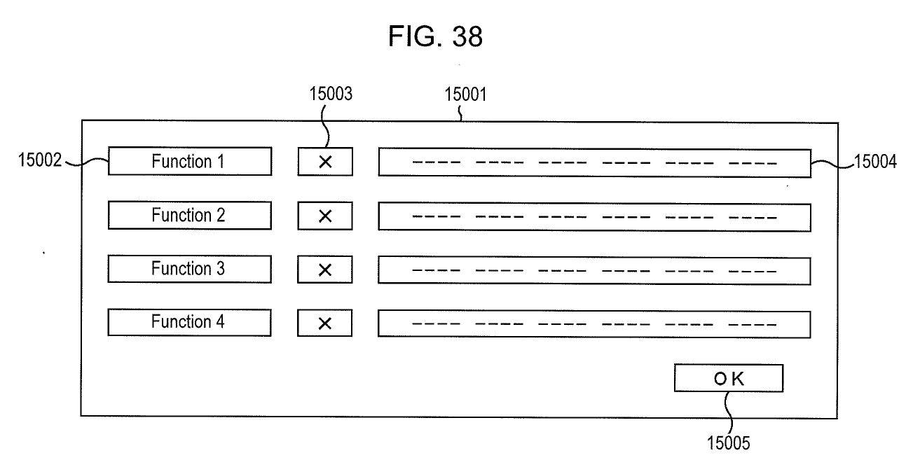

A description is now given, with reference to FIGS. 38 through 43, of revoked license key issue processing. The revoked license key is an example of revoked license information.

The device (for example, the printer 170 shown in FIG. 1) that validates an option by inputting the license key number in this embodiment can also issue a revoked license key by revoking the license to transfer the license to another device having the same option.

FIGS. 38 through 41 illustrate display examples of a touch panel screen of the device 170 for issuing a revoked license key. The user can input a license key to validate an option or to issue a revoked license key on this screen of the device 170.

In FIG. 38, a user interface 15001 having a license-key-installation/revoked-license-issue function is shown. In the user interface 15001, a function name 15002, a license-installation/revoked-license-issue button 15003, a license-key-input/revoked-license-display field 15004, and an OK button 15005 are shown.

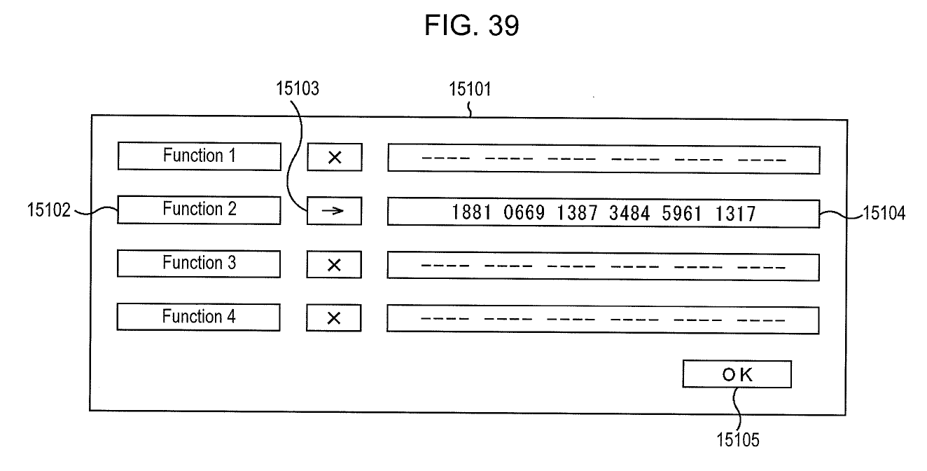

FIG. 39 illustrates an example of a screen 15101 for installing a license by the user with the use of the user interface 15001. To validate function 2 15102, the user presses the license-installation/revoked-license issue button 15103 in the same row as the function 2 15102.

Then, the indication of the license-installation/revoked-license issue button 15103 is changed from x to → to instruct the user to input a license key into a license-key-input/revoked-license display field 15104. The user inputs a license key into the display field 15104 and presses the OK button 15105. In the example shown in FIG. 39, “1881 0669 1387 3484 5961 1317” is input as the license key.

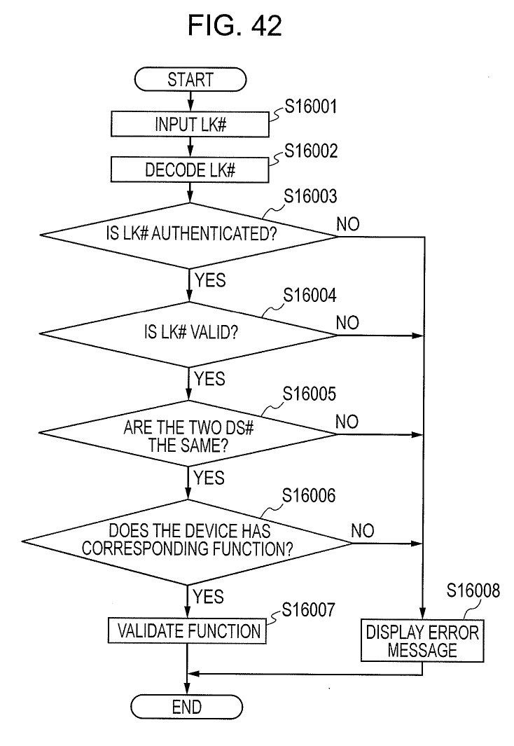

FIG. 42 is a flowchart illustrating license key installation processing performed by the device 170. In step S16001, the user inputs a license key and presses the OK button 15105 on the screen 15101. Then, in step S16002, the device 170 decodes the input license key. In exemplary embodiments, the license key has been encrypted by using the DES algorithm and a common key has been installed in the device 170 and in the license information issue server 101.

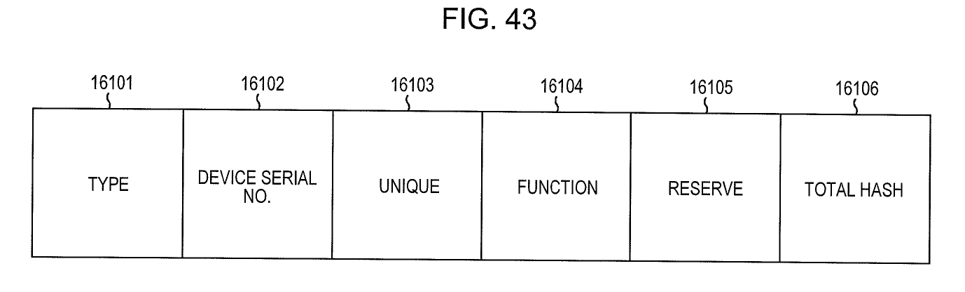

The license key has a structure, such as that shown in FIG. 43. A type field 16101 indicates whether the license key is valid or is revoked to be transferred to another device. In exemplary embodiments, if the license key is valid, the type field 16101 is set to 0, and if the license key is revoked, the type field 16101 is set to 1. A device serial No. field 16102 indicates the unique number of the device 170 into which the license key can be installed. A unique field 16103 is used, when a license key is reissued for the same function of the same device 170, for differentiating the reissued license key from the old license key. When a license key is reissued for the same function of the same device 170, the value of the unique field 16103 is incremented by one. A function field 16104 indicates a function provided for the device 170 to be validated by this license key. A reserve field 16105 is an unused area. A total hash field 16106 designates a hash value of consecutive values of the type field 16101, the device serial No. field 16102, the unique field 16103, a function field 16104, and the reserve field 16105 by using an algorithm (e.g., the MD5 algorithm) to check the integrity of the license key.

Upon completing the decoding of the license key in step S16002, in step S16003, the device 170 compares the total hash value read from the license key to be installed with the calculated hash value from the consecutive values of the individual fields as described above by the algorithm (e.g., the MD5 algorithm) to check the integrity of the license key.

If the license key is authenticated in step S16003, the device 170 determines in step S16004 from the type field 16101 of the license key whether the license key is valid. If the type field 16101 indicates 0, the device 170 determines that the license key is valid to proceed to step S16005 to determine whether the value of the device serial No. field 16102 of the license key coincides with the device serial number of the device 170.

If the two device serial numbers are the same, it is determined in step S16006 whether the device 170 has the function indicated in the function field 16104 of the license key. If the device 170 has the corresponding function, the device 170 validates the function in step S16007, and the license key installation processing is completed. If any one of the outcomes of steps S16003 through S16006 is NO, i.e., if it is determined in step S16003 that the integrity of the license key number is not authenticated, if it is determined in step S16004 that the license key number is not valid, if it is determined in step S16005 that the two device serial numbers are different, or if it is determined in step S16006 that the device 170 does not have the corresponding function, in step S16008, the device 170 displays an error message, and the processing is then terminated.

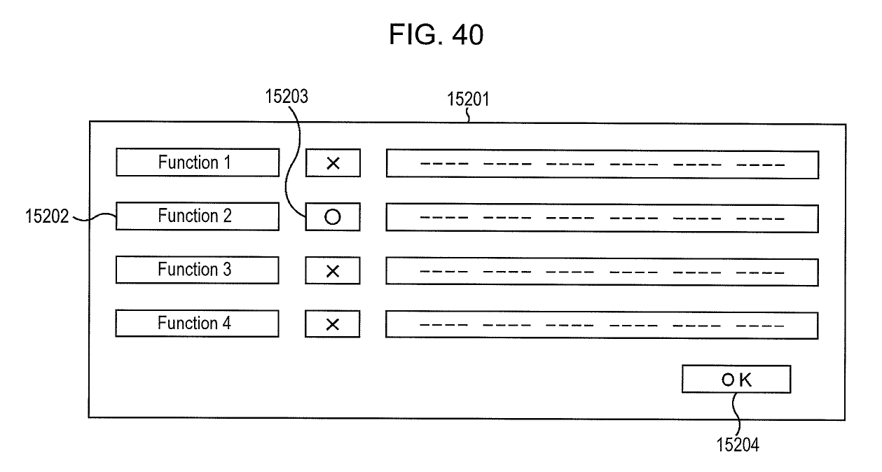

FIG. 40 illustrates a screen 15201 in which the license key of the function 2 15202 is installed and the function 2 15202 is validated (functions 1, 3, and 4 are not valid). A button 15203 with x indicates that the function in the same row as the button 15203 is not valid. When the user presses the x button 15203 and inputs the suitable license key, and presses an OK button 15204, the function in the same row can be validated. The button 15203 with ∘ indicates that the license key has been installed and the function is validated. When the user presses the button 15203, the device 170 issues a revoked license key to revoke the function in the same row as the ∘ button 15203.

The revoked license key can be obtained by decrypting the original license key by the encryption algorithm (e.g., the DES algorithm) and then changing the type field 16101 to 1 and by re-encrypting the decrypted license key by the encryption algorithm (e.g., the DES algorithm).

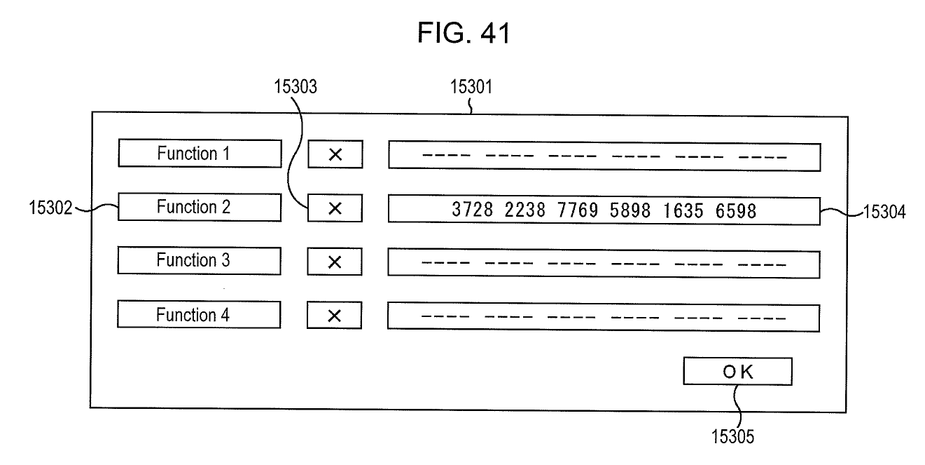

When the user presses the ∘ button 15203, the screen 15201 of the device 170 is changed to a screen 15301 shown in FIG. 41, and a revoked license key (“3728 2238 7769 5898 1635 6598” in the example shown in FIG. 41) is indicated in a license-key-input/revoked-license display field 15304.

Simultaneously with the display of the revoked license key, in the device 170, the license key number revoked by the user is stored in a non-volatile memory area. Then, when the user inputs the revoked license key to re-validate the function, the device 170 recognizes the revoked license key number in step S16004 of FIG. 42 in the license key installation processing and displays an error message in step S16008 to prevent the corresponding function from being validated.

### Description of Transfer License Key Issue Using Revoked License Key

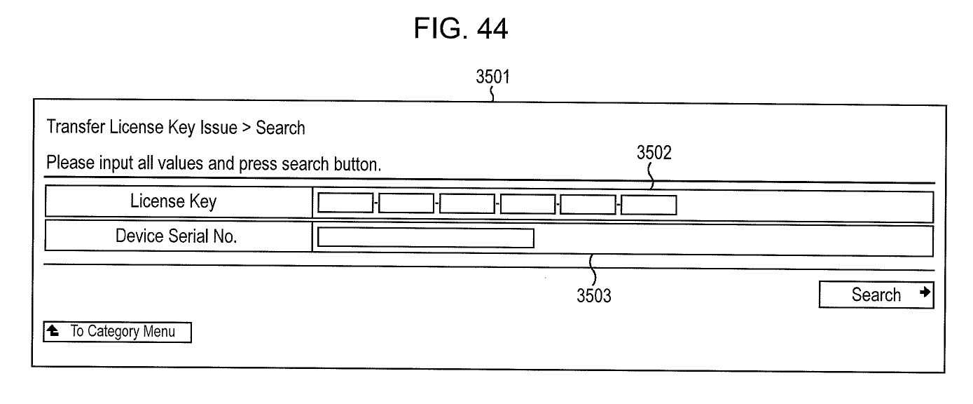

Next, A description is given, with reference to FIGS. 44 through 48, of transfer license key issue processing by using a revoked license key. The transfer license key is an example of transfer license information.

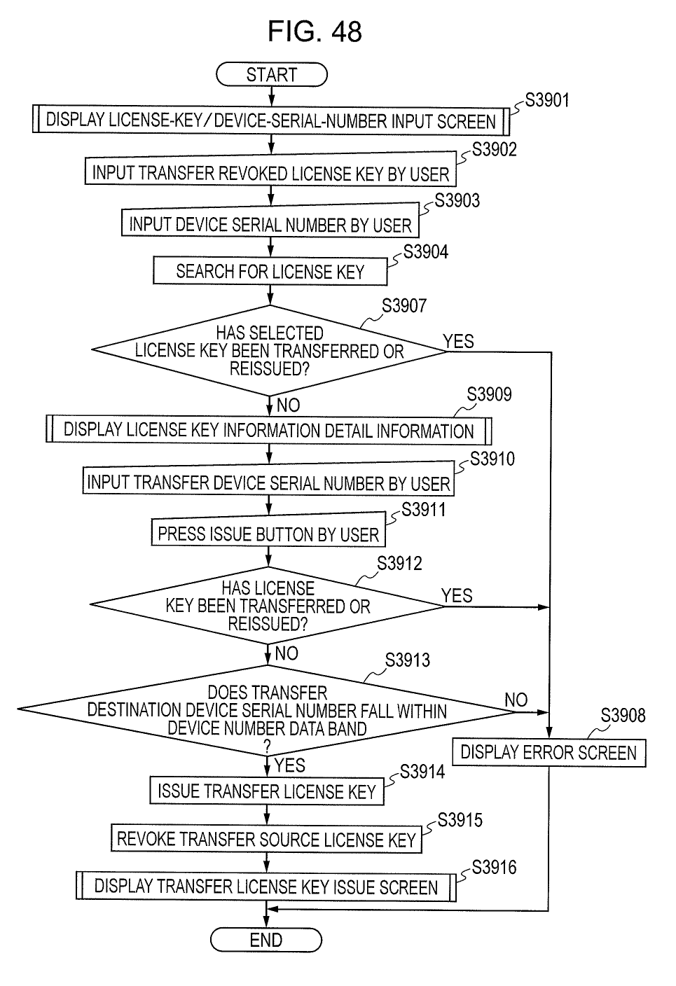

In response to a request from an end user to transfer a license key used in an old device to a new device, a license administrator performs revoked license key issue processing in the old device and starts a predetermined license key transfer operation, and then, the processing indicated by the flowchart of FIG. 48 is started.

In step S3901, the license information issue server 101 displays, as shown in FIG. 44, a license-key/device-serial-number input screen 3501 on the display device of a license administrator terminal. The license administrator inputs the revoked license key and the device serial number of the old device into a license key input field 3502 and a device serial number input field 3503, respectively.

Then, in step S3902, the license administrator inputs the revoked license key, and then inputs the device serial number in step S3903. In step S3904, the license information issue server 101 sets the type field 16101 of the input revoked license key to be 0 to calculate the license key before being revoked, and searches for the original license key.

Subsequently, in step S3907, the license information issue server 101 checks by referring to the license key information table 5770 whether the original license key calculated from the revoked license key has already been transferred or reissued.

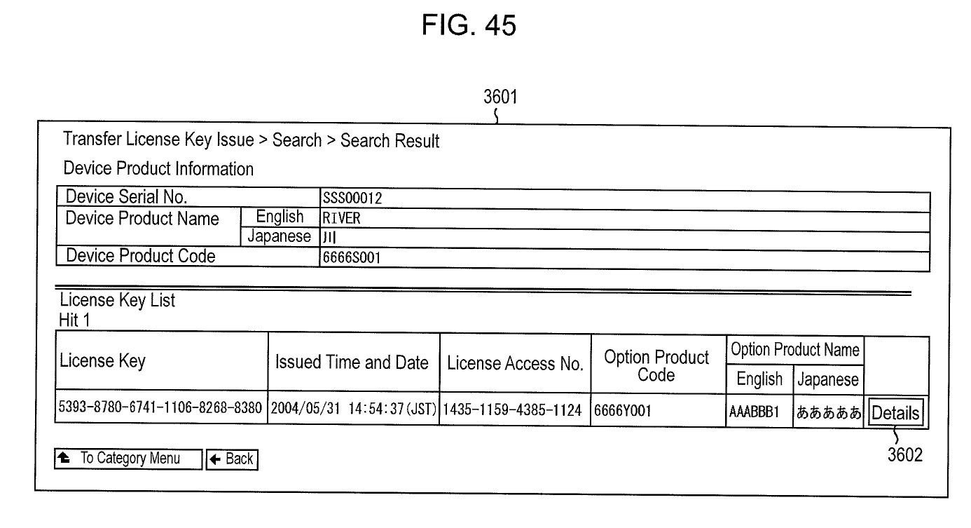

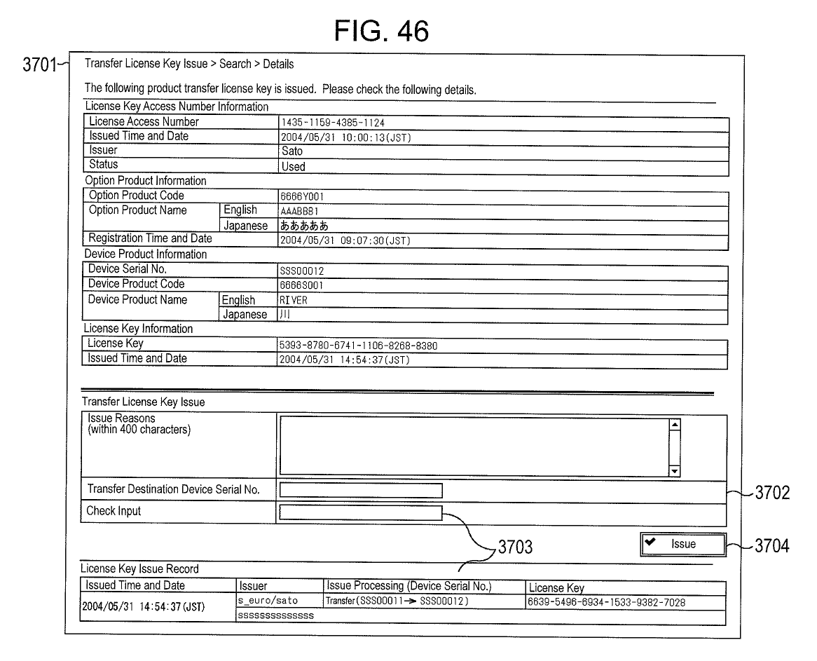

If the license key has been transferred or reissued, in step S3908, the license information issue server 101 displays an error screen on the license administrator terminal and processing ends. If the license key has not been transferred or reissued, in step S3909, on an information display screen 3601 shown in FIG. 45, the license information issue server 101 searches for license key detailed information (license access number, option product information, and device product information) from the license key table 5770, the license access number table 5760, the option product information table 5710, the option-product/device-product association table 5730, and the device product information table 5720. When a detail button 3602 is pressed, a license key information detail screen 3701 is displayed, as shown in FIG. 46, as search result details.

Then, in step S3910, the license administrator inputs a transfer-destination device serial number into an input window 3702 of an input field 3703. In step S3911, the license administrator presses an issue button 3704. In response to a request to issue a transfer license key, in step S3912, the license information issue server 101 checks by referring to the license key information table 5770 whether the transfer license key has already been transferred or reissued. If the transfer license key has been transferred or reissued, the license information issue server 101 displays an error screen on the license key administrator terminal (step S3908) and processing ends.

If it is determined in step S3912 that the license key has not been transferred or reissued, in step S3913, the license information issue server 101 searches the device number data band information table 5780 from the device product code 5721 of the device product information table 5720 searched in step S3909 to check whether the input transfer-destination device serial number falls within the device number data band. If the transfer-destination device serial number is found to be out of the device number data band, in step S3908, the license information issue server 101 displays the error screen on the license key administrator terminal (step S3908) and processing ends.

If the transfer-destination device serial number is found to be within the device number data band, in step S3914, the license information issue server 101 generates a transfer license key. In step S3915, the license information issue server 101 registers the generated transfer license key in the license key information table 5760, and turns on the transfer-source-license-key transferred/reissued flag to prohibit the use of the license key.

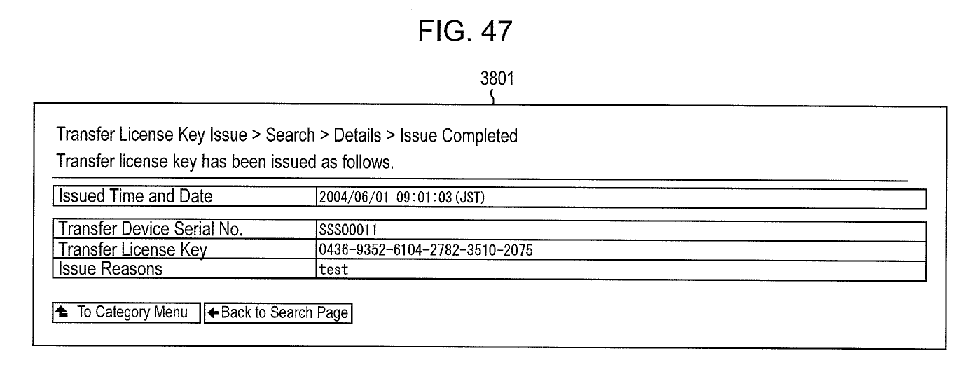

Finally, in step S3916, the license information issue server 101 displays a transfer license key issue screen 3801 shown in FIG. 47. The license administrator obtains the transfer license key generated from the transfer license key issue screen 3801 to complete the transfer license key issue processing using a revoked license key.

The end user can transfer the license key to the transfer device having the transfer device serial number which is input during the transfer license key issue processing.

### Modified Examples

The present invention has been described in detail by way of an exemplary embodiment. The invention can be used in a system including a plurality of devices or an apparatus including a single device.

In the present invention, a software program implementing the functions of the above-described embodiment may be supplied to a system or an apparatus directly or from a remote place, and a computer of the system or the apparatus can read and execute the supplied program code. In this case, if the program code includes program functions, they do not have to be in the form of a program.

The computer program can be any type, such as object code, a program executed by an interpreter, or script data supplied to an operating system (OS) as long as it has program functions.

A recording medium for supplying the program may be a floppy disk, a hard disk, an optical disc, a magneto-optical (MO) disk, a compact disc read only memory (CD-ROM), a CD-recordable (CD-R), a CD-rewritable (CD-RW), magnetic tape, a non-volatile memory card, a ROM, or a DVD (including a DVD-ROM or a DVD-R).

The program may be supplied in the following manner. A user may access an Internet homepage by using a browser of a client computer and download the computer program itself of an embodiment of the present invention or a file containing a compressed automated installation function into a recording medium, such as a hard disk. Alternatively, the program code forming the program of an embodiment of the present invention may be divided into a plurality of files, and the files may be downloaded from different homepages. That is, a World Wide Web (WWW) server may allow a plurality of users to download program files for implementing the functions of an embodiment of the present invention by using a computer.

Additionally, the program of an embodiment of the present invention may be encrypted and stored in a storage medium, such as in a CD-ROM, and is distributed to users. Then, only the users who have cleared predetermined conditions are allowed to download decrypting key information from an Internet homepage to decrypt the encrypted program by using the key information and to install the decrypted program into the computer.

As stated above, the computer may read and execute the program to implement the functions of the above-described embodiment. Alternatively, an OS running on the computer may execute part of or the entire processing in response to instructions of the program to implement the functions of the embodiment.

Additionally, the program read from the recording medium may be written into a memory provided for a feature expansion board or a feature expansion unit inserted into or connected to the computer, and then, in response to the instructions of the program, the CPU provided for the feature expansion board or the feature expansion unit executes part of or the entire processing, thus implementing the functions of the embodiment of the present invention.

As described above, to register a product for selling application software, by specifying a product type according to the sales entity and distribution route, and whether or not licensing conditions are registered and whether or not the unique number is registered, one application can be registered as different products having different sales conditions, thus enhancing the efficient management of sales of software applications.

Additionally, the product registration can be implemented in the following manner.

A sales company, which serves as a first sales entity, issues a software ID code to a product and sells the product with the issued software ID code. Then, a user purchases the product and inputs the software ID code contained in the package and the device serial number uniquely identifying a device into which the software is installed to obtain license information.

A software developer, which serves as a second sales entity, issues a software ID code to a product and contains the issued software ID code in the product, and then, a first sales entity sells the product. Then, a user purchases the product and inputs the software ID code contained in the package and the device serial number uniquely identifying a device into which the software is installed to obtain license information.

A product can be registered without licensing conditions, and when obtaining license information, a first sales entity specifies licensing conditions to obtain the license information based on the specified licensing conditions and sells a product package with the license information.

A product can be registered without licensing conditions, and when obtaining license information, a first sales entity specifies licensing conditions and also inputs the device serial number uniquely identifying a device into which the software is installed to obtain license information based on the specified licensing conditions and the device serial number. Then, the product package with the obtained license information is sold.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Applications No. 2004-264496 filed Sep. 10, 2004, and No. 2005-257942 filed Sep. 6, 2005, which are hereby incorporated by reference herein.

1. A license transfer system comprising a user terminal and a license information issue server connected to each other via a network,
the user terminal comprising:
a revoked license information issue unit configured to generate and issue revoked license information for revoking a license of a transfer source device,
the license information issue server comprising:
a transfer license information issue unit configured to generate and issue transfer license information based on the revoked license information received from the user terminal and information unique to a transfer destination device; and
a license information revoking unit configured to revoke license information concerning an option function of the transfer source device when the transfer license information is issued by the transfer license information issue unit.

2. An information processing apparatus forming a network system by being connected to a license information issue server via a network, the information processing apparatus comprising:
a revoked license information issue unit configured to generate and issue revoked license information when transferring a license contained in a transfer source device to a transfer destination device; and
a validating unit configured to validate an option function of the transfer source device by using license information received from the license information issue server.

3. The information processing apparatus according to claim 2, further comprising an integrity verifying unit configured to verify integrity of the license information received from the license information issue server,
wherein the validating unit is configured to validate the option function when the integrity of the license information is verified by the integrity verifying unit.

4. The information processing apparatus according to claim 2, further comprising a validity verifying unit configured to verify validity of the license information,
wherein the validating unit is configured to validate the option function when the validity of the license information is verified by the validity verifying unit.

5. The information processing apparatus according to claim 2, further comprising a device number identifying unit configured to verify an identity of a device number of a device which starts the option function,
wherein the validating unit is configured to validate the option function when the identity of the device number is verified by the device number identifying unit.

6. A license information issue server comprising:
a transfer license information issue unit configured to generate and issue transfer license information based on revoked license information and information unique to a transfer destination device received from an information processing apparatus; and
a license information revoking unit configured to revoke license information of a transfer source device when the transfer license information is issued by the transfer license information issue unit.

7. The license information issue server according to claim 6, further comprising a transfer determining unit configured to determine whether license information concerning the license information for an option function to be transferred has already been transferred or reissued,
wherein the license information for the option function is not issued when the transfer determining unit determines that the license information for the option function has been transferred or reissued.

8. The license information issue server according to claim 6, further comprising a device number determining unit configured to determine whether a device number of the transfer destination device falls within a predetermined device number band,
wherein the license information for an option function is not issued when the device number of the transfer destination device is out of the predetermined device number band.

9. A method for controlling a user terminal and a license information issue server connected to each other via a network, the method comprising:
a revoked license information issue step of generating and issuing, by the user terminal, revoked license information for revoking a license of a transfer source device;
a transfer license information issue step of generating and issuing, by the license information issue server, transfer license information based on the revoked license information received from the user terminal and information unique to a transfer destination device; and
a license information revoking step of revoking, by the license information issue server, license information concerning an option function of the transfer source device when the transfer license information is issued in the transfer license information issue step.

10. A control program for controlling a user terminal and a license information issue server connected to each other via a network, the control program allowing a computer to execute a method according to claim 9.

11. An information processing method for use in an apparatus for controlling a network system by communicating with a license information issue server, the information processing method comprising:
a revoked license information issue step of generating and issuing revoked license information when transferring a license contained in a transfer source device to a transfer destination device; and
a validating step of validating an option function of the transfer source device by using license information received from the license information issue server.

12. The information processing method according to claim 11, further comprising an integrity verifying step of verifying integrity of the license information received from the license information issue server,
wherein the validating step validates the option function when the integrity of the license information is verified in the integrity verifying step.

13. The information processing method according to claim 11, further comprising a validity verifying step of verifying validity of the license information,
wherein the validating step validates the option function when the validity of the license information is verified in the validity verifying step.

14. The information processing method according to claim 11, further comprising a device number identifying step of verifying an identity of a device number of a device which starts the option function,
wherein the validating step validates the option function when the identity of the device number is verified in the device number identifying step.

15. A control program for controlling an apparatus that controls a network system by communicating with a license information issue server, the control program allowing a computer to execute an information processing method according to claim 11.

16. A license information transfer method comprising:
a transfer license information issue step of generating and issuing transfer license information based on revoked license information and information unique to a transfer destination device received from a user terminal; and
a license information revoking step of revoking license information of a transfer source device when the license information is issued in the transfer license information issue step.

17. The license information transfer method according to claim 16, further comprising a transfer determining step of determining whether license information concerning the license information for an option function to be transferred has already been transferred or reissued,
wherein the license information for the option function is not issued when the transfer determining step determines that the license information for the option function has been transferred or reissued.

18. The license information transfer method according to claim 16, further comprising a device number determining step of determining whether a device number of the transfer destination device falls within a predetermined device number band,
wherein the license information for the option function is not issued when the device number of the transfer destination device is out of the predetermined device number band.

19. A control program allowing a computer to execute a license information transfer method according to claim 18.
